(19) United States
(12) Patent Application Publication
(10) Pub. No.: US 2007/0258359 A1
(43) Pub. Date: Nov. 8, 2007

(54) NETWORK SYSTEM, NODE, NODE CONTROL PROGRAM, AND NETWORK CONTROL METHOD

(75) Inventors: Daisaku OGASAWARA, Tokyo (JP); Nobuyuki ENOMOTO, Tokyo (JP); Hajime MIZOGUCHI, Tokyo (JP); Keiichi SUNADA, Tokyo (JP); Masaki UMAYABASHI, Tokyo (JP); Youichi HIDAKA, Tokyo (JP); Atsushi IWATA, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/572,970

(22) PCT Filed: Jul. 29, 2005
(86) PCT No.: PCT/JP05/14377

§ 371 Date: May 23, 2007

(30) Foreign Application Priority Data
Jul. 30, 2004 (JP) 2004-223922

(51) Int. Cl. H04J 3/14; H04J 1/16

(52) U.S. Cl. 370/218; 370/252

(57) ABSTRACT

A network system in which a network adopting a node redundancy protocol and a network adopting an STP protocol as other protocol for managing a state of a port coexist, which is configured to manage, by the STP protocol as other protocol, a state of a port which belongs to a master node 10 and a backup node 20 forming the network adopting the STP protocol and is under the management of the node redundancy protocol and also under the management of the STP protocol, and in which the master node 10 or the backup node 20 transmits a Hello message as a control frame for monitoring a node and a link to all or a part of nodes connected to the port under the management of the node redundancy protocol, as well as transmitting a Flush message as a control frame for rewriting a forwarding database to all or a part of nodes connected to the port under the management of the node redundancy protocol at the time of switching to a master mode.

### FIELD OF THE INVENTION

The present invention relates to a network system enabling service operation to be continued without stopping communication when such a failure occurs as node-down or link cut-off in a network and, more particularly, to a network system enabling communication to be continued when a failure occurs due to node redundancy.

### DESCRIPTION OF THE RELATED ART

Description will be first made, with respect to one example, of a procedure of transferring a frame in a network where a frame is transferred by using information related to a frame transfer path calculated by a Spanning Tree Protocol (STP) (hereinafter referred to as an STP network) as one of protocols for managing a state of a port.

Assume, for example, that in a network having such network topology as shown in FIG. 45, a heavy path (spanning tree) in FIG. 45 is calculated by the STP.

At the transfer of a frame from a terminal under a node 5 to a terminal under a node 3 in this network, the frame is transferred through a node 1.

Similarly, when transferring a frame to a terminal under a node 2, the transfer is made through the node 1.

When the node 1 develops a fault in the above-described STP network, a problem occurs that the node 5 is allowed to execute no frame transfer at all to the terminals under the node 3 and the node 2.

As a method of eliminating such a problem is duplicating a node to continue frame transfer, even when one node develops a fault, by using other node having no failure.

Known as conventional node redundancy protocols having a node not belonging to an STP network duplicated are VSRP (Virtual Switch Redundancy Protocol) (Foundry Switch and Router Installation and Basic Configuration Guide, Chapter 12 “Configuring Metro Features” (http://www.foundrynet.com/services/documentation/sribcg/ Metro.html#61625): Literature 2), ESRP (Extreme Standby Router Protocol) (Extreme Ware 7.2.0 Software User Guide, Chapter 15, page 347-376 (http://www. extremenetworks.com/services/documentation/swuserguides.a sp): Literature 3) and the like.

Description will be made in the following, with reference to FIG. 39, of common operation executed when such a failure occurs as node-down or link cut-off in a network system to which a conventional node redundancy protocol which makes a node not belonging to an STP network redundant is applied.

In a network system shown in FIG. 39 to which a conventional node redundancy protocol is applied, a master node 210 ad a backup node 220 exist as a pair of redundant nodes. The master node 210 and the backup node 220 are connected with each other via nodes (hereinafter referred to as Aware node) 230 and 240 to which they are directly connected (coupled).

In such a network system, the master node 210 is in an operation state called master mode of the node redundancy protocol and transmits and receives an ordinary frame, as well as periodically transmitting a Keepalive frame (Hello message) through member ports P1 and P2 of the node redundancy protocol.

A member port of the node redundancy protocol in the conventional art denotes a port at which the node redundancy protocol is valid, that is, a port whose port state is managed by the node redundancy protocol. As a port state, two states are defined, a forwarding state and a blocking state, with the forwarding state representing a state where a received framed is transferred with reference to destination information and the blocking state representing a state where a received frame is abandoned without transfer.

Among received frames, a Hello message and a Flush message as control frames of the node redundancy protocol or control frames used for other protocols are sent to a module which processes a control frame in a node irrespective of a port state of an input port.

Accordingly, in the above-described state, the port states of the member ports P1 and P2 of the node redundancy protocol at the master node 210 are set to the forwarding state.

The Aware nodes 230 and 240 respectively transmit a Hello message received at the port P1 on the master node 210 side through the port P2 on the backup node 220 side.

In addition, the backup node 220 is in an operation state called backup mode of the node redundancy protocol and monitors the Hello message or the Flush message among frames received at the member ports P1 and P2 and abandons the remaining frames.

Accordingly, in this state, the ports states of the member ports P1 and P2 of the node redundancy protocol at the backup node 220 are set to the blocking state.

In the above-described state, terminals under the Aware nodes 230 and 240 respectively execute communication via the master node 210 in the master mode.

Here, description will be made of a case, as shown in FIG. 40, where the master node 210 goes down to prevent transmission of the Hello message from the master node 210. When failing to receive the Hello message a predetermined number of times in succession, the backup node 220 starts processing of periodically transmitting the Hello message through the member ports P1 and P2, as well as monitoring whether the Hello message successively transmitted from the master node 210 is received.

When failing to receive the Hello message transmitted from the master node 210 even after a lapse of a predetermined time after starting the transmission of the Hello message, the backup node 220 determines that the master node 210 goes down and switches to the master mode.

The backup node 220 switched to the master mode brings the member ports P1 and P2 in the blocking state to the forwarding state, as well as transmitting the Flush message through the member ports P1 and P2 which indicates that the itself switches to the master mode. Thereafter, the backup node 220 successively transmits the Hello message through the member ports P1 and P2 periodically.

Upon receiving the Flush message, the Aware nodes 230 and 240 rewrite the contents of an FDB (Forwarding Data Base) which stores a correspondence between a destination indicated in the frame and an output port of the frame. More specifically, an output port name of an entry of the FDB in which a port having received the Hello message before receiving the Flush message is rewritten to a port receiving the Flush message. For example, at the Aware node 230 in the network shown in FIG. 40, such FDB rewriting as follows is executed. Since the port having received the Hello message before the reception of the Flush message from the node 220 is the P1, as to the entry in which P1 is recited as the output port name, the output port name is rewritten to the port P2 receiving the Flush message.

Thus, the terminals under the Aware nodes 230 and 240 are respectively allowed to continue communication via the backup node 220 which has switched to the master mode.

Possible failure different from the above-described down of the master node is cut-off of a link. Operation executed in this case will be described with reference to FIG. 41. As shown in FIG. 41, when a link is cut off between the master node 210 and the Aware node 230, the master node 210 senses the link cut-off to operate to lower priority of its own node. Then, the node transmits the Hello message with information about the lowered priority stored. On the other hand, the backup node 220 having received the Hello message, by knowing that the priority of the master node 210 becomes lower than that of its own node (the backup node 220), starts the processing of periodically transmitting the Hello message which stores the priority of its own node through the member ports P1 and P2, as well as monitoring the Hello message successively transmitted from the master node 210.

The master node 210 having received the Hello message from the backup node 220, by knowing that the priority of the backup node 220 becomes higher than the priority of its own node (master node 210), switches to the backup mode to change the port states of the member ports P1 and P2 from the forwarding state to the blocking state, as well as stopping the processing of periodically transmitting the Hello message. Thereafter, the master node 210 monitors the Hello message periodically transmitted form the backup node 220.

When the master node 210 stops transmission of the Hello message to prevent the backup node 220 from receiving the Hello message transmitted from the master node 210 for a predetermined time period, the backup node 220 switches to the master mode.

The backup node 220 switching to the master mode brings the member ports P1 and P2 into the forwarding state, as well as transmitting the Flush message through the member ports P1 and P2. Thereafter, the backup node 220 successively transmits the Hello message through the member ports P1 and P2 periodically.

At this time the Flush message and the Hello message are transmitted with the priority information of the backup node 220 stored.

Operation of the Aware nodes 230 and 240 having received the Flush message is the same as that described above. More specifically, among the entries of the FDB, an output port name of an entry which is a port having received the Hello message before switching of the backup node 220 is rewritten to the port at which the Flush message has been received.

The foregoing enables the terminals under the Aware nodes 230 and 240 to continue communication via the backup node 220 switched to the master mode.

The foregoing arrangement enables service operation to be continued by making a node be redundant by using a conventional node redundancy protocol without stopping communication even when a failure occurs such as node down or link cut-off.

There occurs a problem, however, that frame transfer is disabled when a conventional node redundancy protocol is applied to a node in a network to which other protocol which manages a port state of a port (hereinafter referred to as other protocol) such as the STP, for example, is applied.

Shown, for example, in FIG. 42 is a network to which a conventional node redundancy protocol is applied to an edge portion of an STP network. In FIG. 42, member ports of the node redundancy protocol at both the master node 210 and the backup node 220 are P1 to P4. On the other hand, noting the STP network side, the member ports of the STP of the master node 210 and the backup node 220 are set to be P3 and P4. Member port of the STP denotes a port at which the STP is valid, that is, a port whose port state is managed by the STP. In a case of such setting, contention between the STP and the node redundancy protocol occurs related to management of the port states of the ports P3 and P4 to prevent frame transfer as will be described later.

In addition, when the ports P1 and P2 of the master node 210 and the backup node 220 are set to be member ports of the node redundancy protocol and their member ports P3 and P4 are set to be member ports of the STP in FIG. 42 in order to avoid such contention as described above, the above-described Flush message fails to be transmitted to nodes 250 and 260 connected to the member ports P3 and P4 of the STP at the time of switching between the master mode and the backup mode, so that no FDB of the nodes 250 and 260 will be rewritten. In this case, accordingly, until the FDB of the nodes 250 and 260 age out, the nodes 250 and 260 will be allowed no communication (frame transfer).

In the following, description will be made of a problem that contention of management of a port state prevents communication when the ports P3 and P4 of the master node 210 and the backup node 220 are set to be member ports of both the node redundancy protocol and the STP.

In the network having such a structure as shown in FIG. 43, the node 260 communicates with other node via the member ports P4 and P3 of the backup node 220. FIG. 44 shows examples of setting contents of a port state management table 270 which manages a port state of a member port of the STP and setting contents of a port state management table 280 which manages a port state of a member port of the node redundancy protocol in the backup node 220.

As to the ports P1 and P2 of the backup node 220, management of the port state by the STP is invalid and the port state is blocking state under the management by the node redundancy protocol.

As to the ports P3 and P4, the port states by the management of the STP are both the forwarding state and the port states under the management of the node redundancy protocol are both blocking state, resulting in that port states different from each other are set under the STP and the node redundancy protocol.

Since the port state of the ports P3 and P4 under the STP at the backup node 220 are the forwarding state, the node 260 is allowed to communicate with other node via these ports.

On the other hand, since the port states of the ports P3 and P4 under the node redundancy protocol are the blocking state, communication from the node 260 to other node and communication from other node to the node 260 will be cut off at the member ports P4 and P3 of the backup node 220, respectively.

In other words, because even when the port state under the STP is the forwarding state, the port state under the node redundancy protocol is the blocking state, so that a BPDU (Bridge Protocol Data Unit) frame of the STP or an ordinary data frame other than control frames such as a Hello message and a Flush message of the node redundancy protocol will be abandoned. The node 260 is accordingly brought to a state where communication with other node is disabled due to contention of management of port states under the STP and the node redundancy protocol.

A first object of the present invention is to provide a network system, a node and a node control program, and a network control method which enable such a network adopting the node redundancy protocol and a network adopting other protocol as described above to coexist.

A second object of the present invention is to provide a network system, a node and a node control program, and a network control method which solve the problem that when a network adopting the node redundancy protocol and a network adopting other protocol coexist, at the time of switching between a master mode and a backup mode, communication is not allowed until an FDB of a node on the side of the network adopting other protocol ages out.

A third object of the present invention is to provide a network system, a node and a node control program, and a network control method which realize a network system having STP networks connected with each other and enabling reliability to be improved.

A fourth object of the present invention is to provide a network system, a node and a node control program, and a network control method which realize node redundancy of a route node of an STP network and particularly enable occurrence of a failure of a route node whose failure recovery is time consuming to be effectively suppressed.

### SUMMARY OF THE INVENTION

In order to achieve the above-described objects, according to the network system of the present invention, in a network system in which a network adopting the node redundancy protocol and a network adopting other protocol coexist, a state of a port which is a member port belonging to a master node and a backup node forming the network adopting other protocol and being under the management of the node redundancy protocol and which is a port under the management on the side of the network adopting other protocol is managed not by the node redundancy protocol but only by other protocol and at the time of switching of the master node or the backup node to the master mode, a control frame for rewriting a forwarding data base is transmitted to all nodes connected to the member port under the management of the node redundancy protocol.

The present invention enables, by bringing a state of a port under the management of other protocol out of the management of the node redundancy protocol, contention between port management states by the node redundancy protocol and other protocol to be avoided, as well as enabling, by transmitting a Flush message to all the nodes connected to a member port under the management of the node redundancy protocol at the time when operation states of the master node and the backup node under the node redundancy protocol switch, flushing of an FDB of a node connected to a member port under the management of other protocol to be executed.

### BRIEF DESCRIPTION OF THE DRAWINGS

FIG. 1 is a diagram showing a structure of a network system according to a first embodiment to which the present invention is applied;

FIG. 2 is a block diagram showing a structure of a master node and a backup node according to the first embodiment;

FIG. 3 is a block diagram showing a structure of a node outside an STP network which is directly connected to the master node and the backup node according to the first embodiment;

FIG. 4 shows a structure of a node within the STP network which is directly connected to the master node and the backup node according to the first embodiment;

FIG. 5 is a diagram showing setting contents of a node redundancy protocol member port management table and an STP member port management table of the master node in the network system shown in FIG. 1;

FIG. 6 is a diagram showing setting contents of a node redundancy protocol member port management table and an STP member port management table of the backup node in the network system shown in FIG. 1;

FIG. 7 is a diagram showing an example of contents of a port state management table of the master node in the network system shown in FIG. 1;

FIG. 8 is a diagram showing an example of contents of a port state management table of the backup node in the network system shown in FIG. 1;

FIG. 9 is a diagram showing an example of setting contents of a node redundancy protocol member port management table of an Aware node not belonging to the STP network in the network system shown in FIG. 1;

FIG. 10 is a diagram showing an example of setting contents of a node redundancy protocol member port management table of an Aware node not belonging to the STP network in the network system shown in FIG. 1;

FIG. 11 is a diagram showing an example of setting contents of an STP member port management table of an Aware node belonging to the STP network in the network system shown in FIG. 1;

FIG. 12 is a diagram showing an example of setting contents of the STP member port management table of an Aware node belonging to the STP network in the network system shown in FIG. 1;

FIG. 13 is diagram showing a state immediately after the backup node is switched to the master mode in the network system shown in FIG. 1;

FIG. 14 is a diagram showing a state after rewriting of an FDB by Flush message transmission in the network system shown in FIG. 1;

FIG. 15 is a flow chart for use in explaining operation executed when the master node receives a frame in the network system shown in FIG. 1;

FIG. 16 is a flow chart for use in explaining operation executed when the master node receives a frame in the network system shown in FIG. 1;

FIG. 17 is a flow chart for use in explaining operation executed when the master node receives a frame in the network system shown in FIG. 1;

FIG. 18 is a flow chart for use in explaining operation executed when the Aware node not belonging to the STP network receives a frame in the network system shown in FIG. 1;

FIG. 19 is a sequence chart for use in explaining operation of the network system according to the first embodiment;

FIG. 20 is a diagram showing a structure of a network system according to a second embodiment of the present invention, which is application of a node redundancy protocol to a network system with a plurality of VLAN set;

FIG. 21 is a diagram showing an operation state in each VLAN of a master node and a backup node in the second embodiment;

FIG. 22 is a diagram showing setting contents of each VLAN of a node redundancy protocol member port management table in the master node and the backup node in the second embodiment;

FIG. 23 is a diagram showing setting contents of each VLAN of the STP member port management table in the master node and the backup node in the second embodiment;

FIG. 24 is a diagram showing a port state of a member port of the node redundancy protocol in each VLAN, which is set in the port state management table of the master node and the backup node according to the second embodiment;

FIG. 25 is a diagram showing a port state of a member port of the node redundancy protocol in each VLAN, which is set in the node redundancy protocol member port management table of an Aware node belonging to the STP network;

FIG. 26 is a diagram showing a port state of a member port of the node redundancy protocol in each VLAN, which is set in the node redundancy protocol member port management table of an Aware node not belonging to the STP network;

FIG. 27 is a diagram showing a port state of a member port of the node redundancy protocol in each VLAN, which is set in the STP member port management table of the Aware node not belonging to the STP network;

FIG. 28 is a block diagram showing a structure of a master node and a backup node according to a third embodiment of the present invention;

FIG. 29 is a block diagram showing another structure of the master node and the backup node according to the third embodiment;

FIG. 30 is a diagram showing a state immediately after the backup node is switched to the master mode in the third embodiment;

FIG. 31 is a diagram showing a state after rewriting of an FDB by transmission of a BPDU frame with a Topology Change flag set up in the third embodiment;

FIG. 32 is a diagram showing a structure in which a master node and a backup node are provided at a portion where two STP networks are connected with each other according to a fourth embodiment;

FIG. 33 is a diagram showing a network system in which a master node and a backup node function as a route node of an STP network according to a fifth embodiment;

FIG. 34 is a diagram showing a state immediately after the backup node is switched to the master mode due to master node down in the fifth embodiment;

FIG. 35 is a diagram showing a network system in which the route node located at other part than an edge in the STP network is made redundant in the fifth embodiment;

FIG. 36 is a diagram showing a structure of a network system according to a sixth embodiment;

FIG. 37 is a diagram showing a state where all master nodes and backup nodes become master nodes due to cut-off of two links in the network system shown in FIG. 36;

FIG. 38 is a diagram showing an example of setting of a route path cost value for avoiding a problem involved when all the master nodes and backup nodes become the master modes in the sixth embodiment;

FIG. 39 is a diagram showing an example of a network system to which a conventional node redundancy protocol is applied;

FIG. 40 is a diagram for use in explaining operation executed when the backup node switches to the master mode due to master node down in the network system shown in FIG. 39;

FIG. 41 is a diagram for use in explaining operation executed when the backup node switches to the master mode due to occurrence of link cut-off in the network system shown in FIG. 39;

FIG. 42 is a diagram for use in explaining contention of member ports in a network system in which conventional node redundancy protocol and STP coexist;

FIG. 43 is a diagram for use in explaining inconvenience caused by contention of member ports in a network system in which conventional node redundancy protocol and STP coexist;

FIG. 44 is a diagram showing examples of setting contents of a port state management table of the STP and a port state management table of the node redundancy protocol at the backup node in the network system shown in FIG. 43;

FIG. 45 is a diagram showing an example of a network adopting a conventional STP network;

FIG. 46 is a diagram showing a first example of a spanning tree structure for use in explaining the STP network proposed in Literature 1;

FIG. 47 is a diagram showing a second example of a spanning tree structure for use in explaining the STP network proposed in Literature 1;

FIG. 48 is a diagram showing a third example of a spanning tree structure for use in explaining the STP network proposed in Literature 1;

FIG. 49 is a diagram showing a fourth example of a spanning tree structure for use in explaining the STP network proposed in Literature 1;

FIG. 50 is a diagram showing a fifth example of a spanning tree structure for use in explaining the STP network proposed in Literature 1; and

FIG. 51 is a diagram showing a sixth example of a spanning tree structure for use in explaining the STP network proposed in Literature 1.

### DESCRIPTION OF THE PREFERRED EMBODIMENT

In the following, preferred embodiments of the present invention will be described in detail with reference to the drawings.

### First Embodiment

Detailed description will be made of a method of making a node forming an STP network be redundant in the first embodiment.

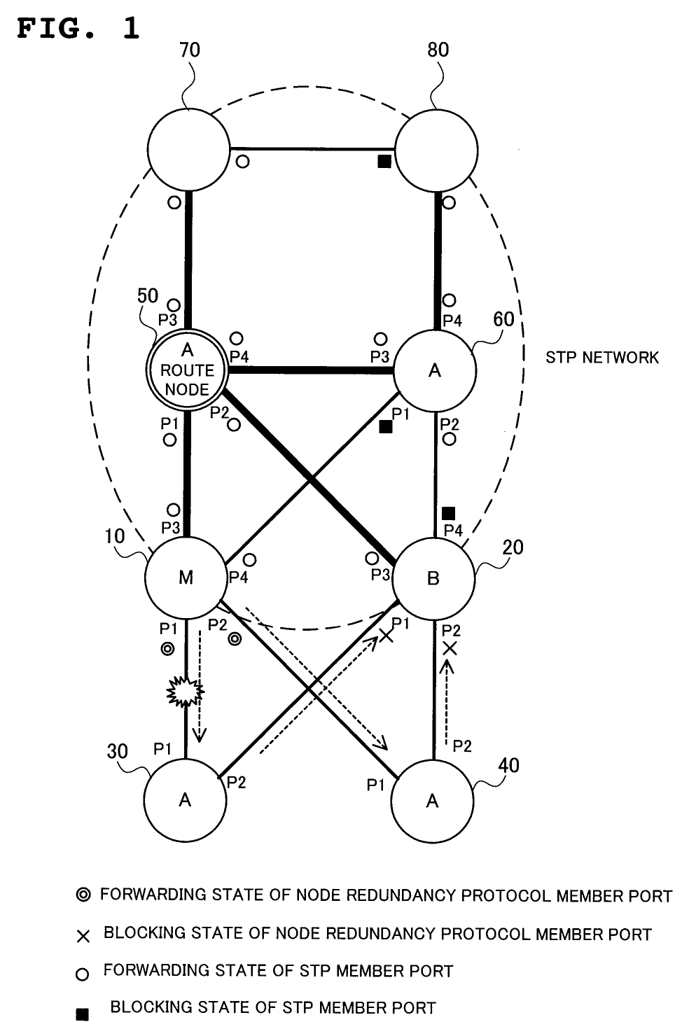

FIG. 1 is a diagram showing a structure of a network system to which the present invention is applied.

To ports P3 and P4 of a master node 10 and a backup node 20, nodes 50 and 60 belonging to an STP network are connected respectively and to ports P1 and P2 of the master node 10 and the backup node 20, nodes 30 and 40 not belonging to the STP network are connected respectively.

In addition, to the nodes 50 and 60 belonging to the STP network, nodes 70 and 80 are connected respectively, which nodes 70 and 80 form the STP network together with the master node 10, the backup node 20 and the nodes 50 and 60.

To the master node 10 and the backup node 20, a node redundancy protocol of the present invention is applied, with one of the master node 10 and the backup node 20 being in an operation state of a master mode and the other being in an operation state of a backup mode in the node redundancy protocol of the present invention, each of which node operates as one of a pair of nodes made redundant.

All of the nodes 50 and 60 belonging to the STP network and the nodes 30 and 40 not belonging to the STP network which are directly connected to the master node 10 and the backup node 20 and made redundant by the node redundancy protocol of the present invention operate as Aware nodes of the master node 10 and the backup node 20.

In the following, structure and operation of the master node 10 and the backup node 20 will be described.

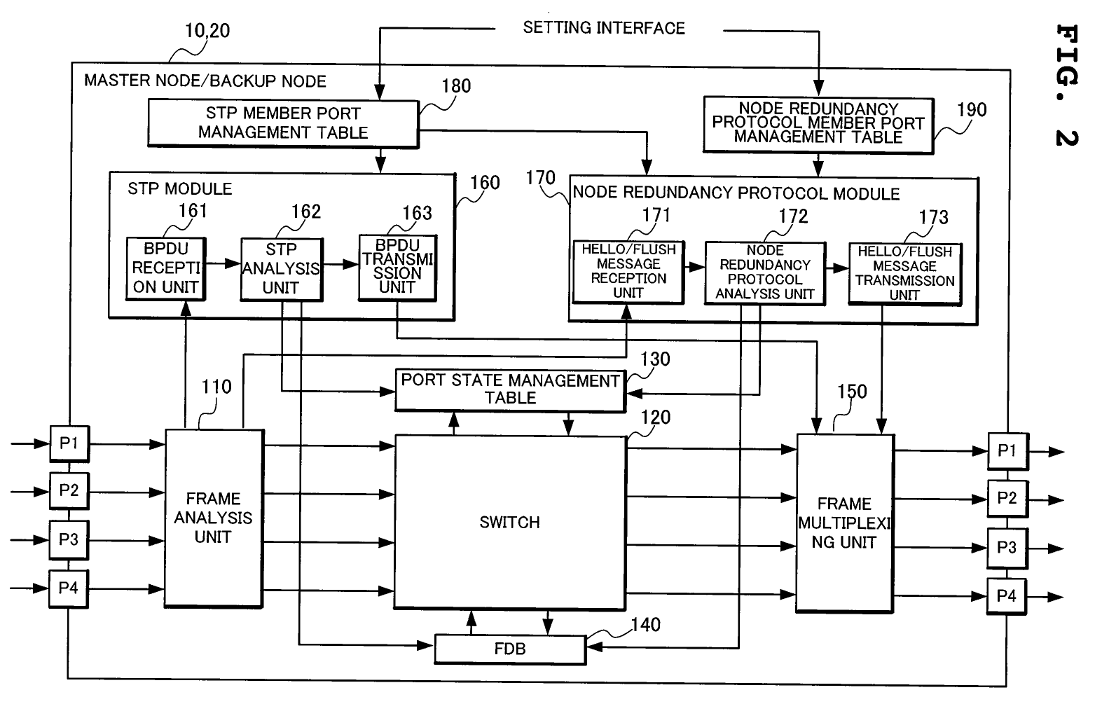

As shown in FIG. 2, the master node 10 includes a frame analysis unit 110, a switch 120, a port state management table 130, an FDB (Forwarding Data Base) 140 and a frame multiplexing unit 150 and includes an STP module 160, a node redundancy protocol module 170, and an STP member port management table 180 and a node redundancy protocol member port management table 190 which are characteristic components of the present invention.

The backup node 20 has the same structure as that of the master node 10.

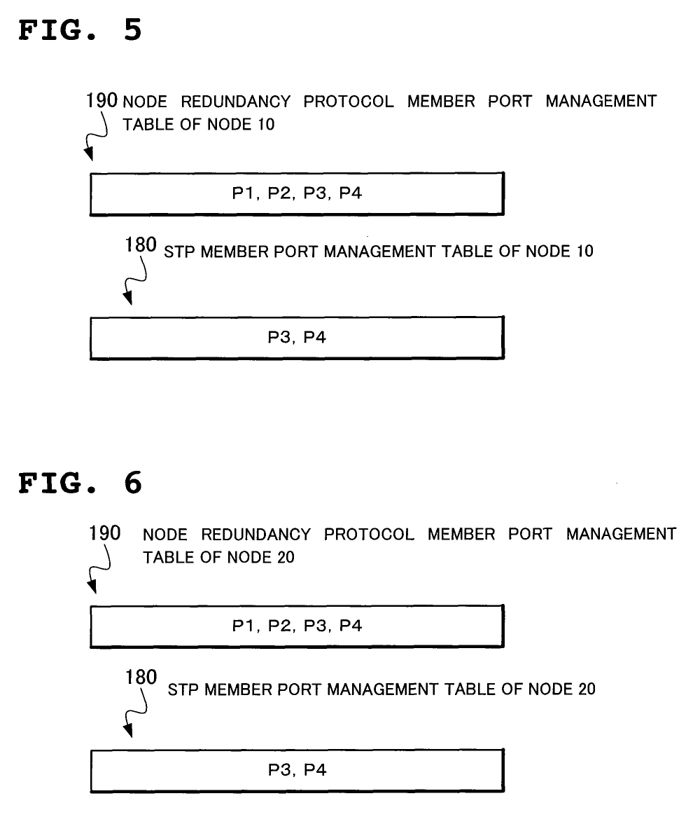

FIG. 5 shows a setting example of the node redundancy protocol member port management table 190 and a setting example of the STP member port management table 180 of the master node 10 in the network structure example shown in FIG. 1.

In the node redundancy protocol member port management table 190 of the master node 10 shown in FIG. 5, the ports P1˜P4 to which the Aware nodes (nodes 30, 40, 50, 60) are directly connected are registered as member ports of the node redundancy protocol of the master node 10.

The management table of these member ports may be manually set at the time of setting up the network or set by a server.

In the STP member port management table 180 of the master node 10 shown in FIG. 5, the ports P3 and P4 to which the nodes 50 and 60 forming the STP network are directly connected are registered as member ports of the STP of the master node 10.

FIG. 6 shows a setting example of the node redundancy protocol member port management table 190 and a setting example of the STP member port management table 180 of the backup node 20 in the network structure example shown in FIG. 1.

In the node redundancy protocol member port management table 190 of the backup node 20 shown in FIG. 6, the ports P1˜P4 to which the Aware nodes (nodes 30, 40, 50, 60) are directly connected are registered as member ports of the node redundancy protocol of the backup node 20.

In the STP member port management table 180 of the backup node 20 shown in FIG. 6, the ports P3 and P4 to which the nodes 50 and 60 forming the STP network are connected are registered as member ports of the STP of the backup node 20.

In the following, operation of the master node 10 will be described. While the description will be here made only of the operation of the master node 10, this is also the case with the operation of the backup node 20.

When the operation state of the master node 10 is in the master mode, a node redundancy protocol analysis unit 172 instructs a Hello/Flush message transmission unit 173 to periodically transmit a Hello message in which information (e.g. priority) related to the node redundancy protocol of its own node is stored through the member ports (P1˜P4) of the node redundancy protocol.

Used as information related to the node redundancy protocol is such information as causes operation states of the master node 10 and the backup node 20 to differ from each other.

In a case, for example, of updating an operation state of the master node 10 from the backup mode to the master mode, information related to the node redundancy protocol of the master node 10 and the backup node 20 should be calculated such that the operation state of the backup node 20 is updated from the master mode to the backup mode.

Description will be here made of one example of a priority calculation method in a case where priority is used as information related to the node redundancy protocol.

As priority, a value as a reference (hereinafter referred to as reference value) is set manually or the like through a default or a setting interface in advance and held in the node redundancy protocol analysis unit 172.

Mainly used as a method of calculating priority of a node is a method executed using a reference value, the number of member ports of the node redundancy protocol and the number of member ports linked up.

In a case, for example, where the reference value of the priority is 100 and the number of member ports of the node redundancy protocol is four of P1˜P4, of which linked up member ports are three of P1˜P3, the priority can be calculated as reference value x (the number of member ports of the node redundancy protocol)/(the number of linked-up member ports of the node redundancy protocol)=100×¾=75.

Other than the above-described priority calculation method, a calculation method taking other information such as information related to other port than a member port of the node redundancy protocol into consideration may be used.

The Hello/Flush message transmission unit 173 generates a Hello message based on information related to the node redundancy protocol of its own node and instructs the frame multiplexing unit 150 to transmit the generated Hello message through the member port of the node redundancy protocol.

When the operation state of the master node 10 is in the backup mode, the Hello message periodically transmitted from a node in the master mode is monitored as will be described later.

In the following, operation executed when the master node 10 receives a frame will be described with reference to the flow charts shown in FIG. 15 to FIG. 17.

Operation executed when the master node 10 receives a frame is independent of an operation state of a node (master mode or backup mode) except when receiving a Hello message or a Flush message as a control frame of the node redundancy protocol.

Frames received at the ports P3 and P4 are all sent to the frame analysis unit 110 (Step S1501).

The frame analysis unit 110 identifies a kind of the received frame (Step 1502) and when the received frame is a BPDU frame as a control frame of the STP, sends the received frame to a BPDU reception unit 161 in the STP module 160 (Step S1503).

Operation of the STP module 160 to follow will be detailed later.

When the received frame is a Hello message or a Flush message as a control frame of the node redundancy protocol, the frame analysis unit 110 sends the received frame to a Hello/Flush message reception unit 171 in the node redundancy protocol module 170 (Step 1504).

Operation of the node redundancy protocol module 170 to follow will be detailed later.

When the received frame is an ordinary data frame other than a control frame of the STP and a control frame of the node redundancy protocol, the frame analysis unit 110 sends the received frame to the switch 120 (Step 1505).

With an input port of the received frame as a key, the switch 120 refers to the port state management table 130 to obtain a port state of the input port (Step 1506).

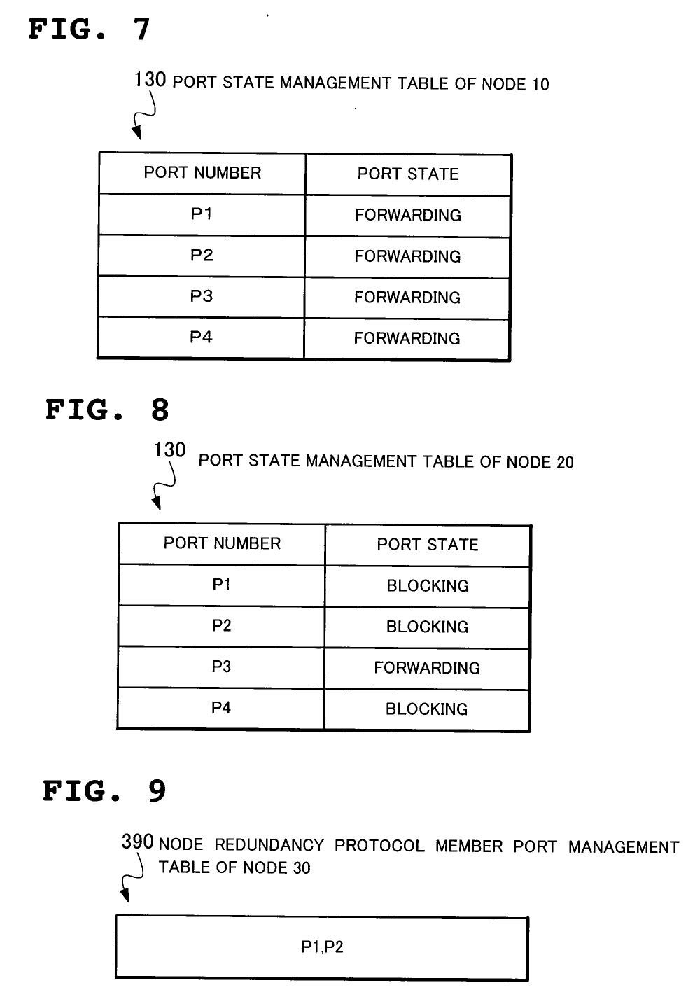

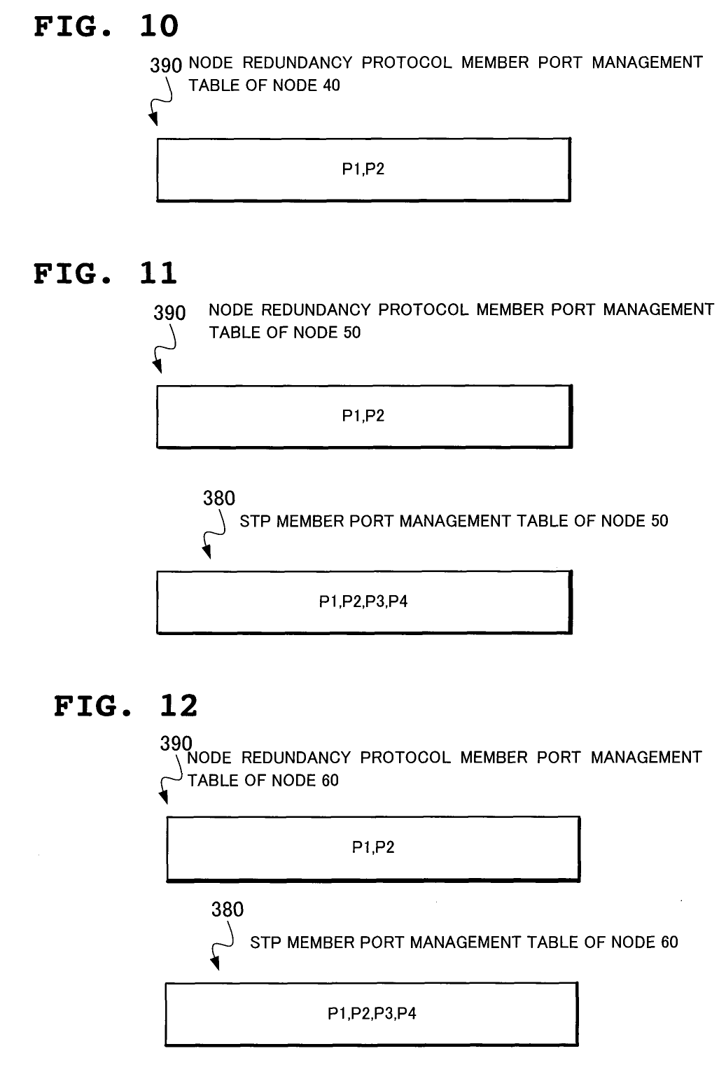

FIG. 7 shows the port state management table 130 of the master node 10 in the network structure example shown in FIG. 1 and FIG. 8 shows an example of the port state management table 130 of the backup node 20 in the network structure example shown in FIG. 1.

The port state management table 130, which is a table for managing a port state (either state of a forwarding state and a blocking state) of each port belonging to the master node 10 or the backup node 20, is referred to by an STP analysis unit 162 and a node redundancy protocol analysis unit 172 to have its contents rewritten.

When the port state of the input port is the blocking state (Step 1507), the switch 120 interrupts processing of transferring a received frame and abandons the received frame (Step 1508).

When the port state of the input port is the forwarding state (Step 1507), the switch 120 searches the FDB 140 with destination information stored in the received frame as a key to obtain output port information of the received frame (Step 1509) and instructs the frame multiplexing unit 150 to transmit the received frame through a port stored in the obtained output port information (Step 1510).

Such a frame transfer method is called unicast transfer.

When output port information related to destination information which is stored in the received frame is not found, the switch 120 refers to the port state management table 130 to instruct the frame multiplexing unit 150 to transmit a received frame through all the ports in the forwarding state excluding the input port.

Such a frame transfer method is called broadcast transfer.

In the following, detailed description will be made of operation of the STP module 160 executed when a received frame is a BPDU frame.

The STP module 160 has the function of managing a port state of the ports (P3, P4), as a member port of the STP, connected to the nodes (node 50, 60) belonging to the STP network and includes the BPDU reception unit 161, an STP analysis unit 162 and a BPDU transmission unit 163.

The STP analysis unit 162 analyzes information related to a transfer path of a frame stored in a BPDU frame received at the BPDU reception unit 161 (e.g. a MAC address, route path cost of a route node) and information related to a transfer path of a frame held by the STP analysis unit 162 itself to update its own information related to the transfer path of the frame (1511), as well determining a port state (forwarding state or blocking state) of the member port of the STP based on the updated information related to the frame transfer path to change the port state management table 130 (Step 1512).

In addition, the STP analysis unit 162 instructs the BPDU transmission unit 163 to transmit a BPDU frame which stores information related to the path of frame transfer through the member port of the STP in order to transmit the updated information related to the transfer path of the frame to other node connected to its own node (Step 1513).

The BPDU transmission unit 163 generates a BPDU frame based on the updated information related to a frame transfer path (Step 1514) and instructs the frame multiplexing unit 150 to transmit the generated BPDU frame through the member port of the STP (Step 1515).

In addition, the STP analysis unit 162 instructs the BPDU transmission unit 163 to periodically transmit a BPDU frame through the member port of the STP.

The BPDU transmission unit 163 generates a BPDU frame based on information related to a transfer path of a frame and instructs the frame multiplexing unit 150 to transmit the generated BPDU frame through the member port of the STP.

In the following, detailed description will be made of operation of the node redundancy protocol module executed when a received frame is a Hello message or a Flush message.

The node redundancy protocol module 170 has the function of managing a port state of the ports (P1, P2, P3, P4) as a member port of the node redundancy protocol connected to the Aware nodes (nodes 30, 40, 50, 60) and includes the Hello/Flush message reception unit 171, the node redundancy protocol analysis unit 172 and the Hello/Flush message transmission unit 173.

Since operation of the node redundancy protocol module 170 depends on an operation state of the master node 10, description will be made in the following separately with respect to a case where the operation state of the master node 10 is in the master mode and a case where the same is in the backup mode.

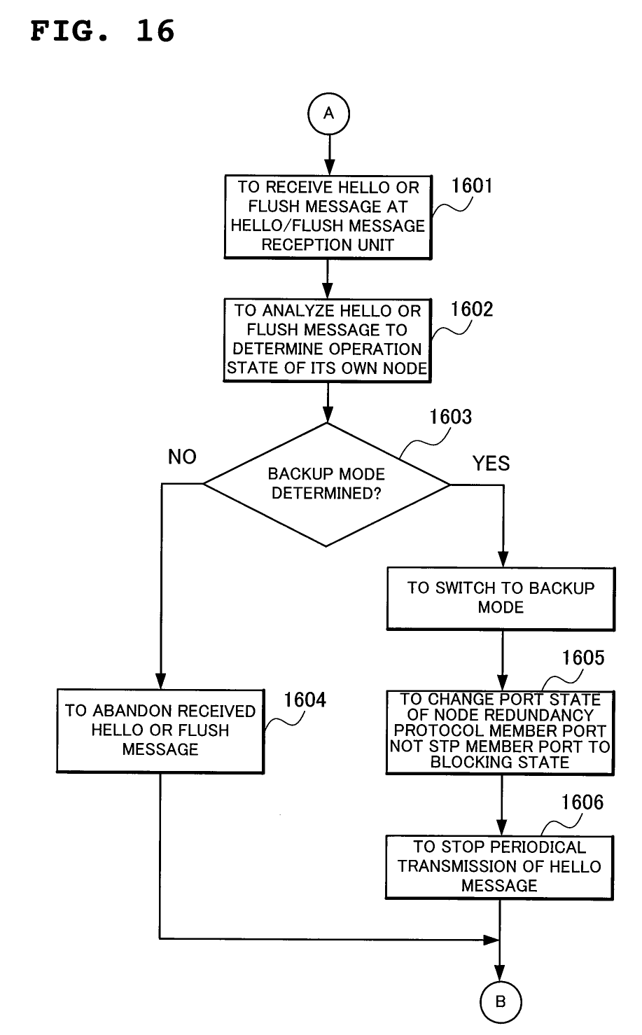

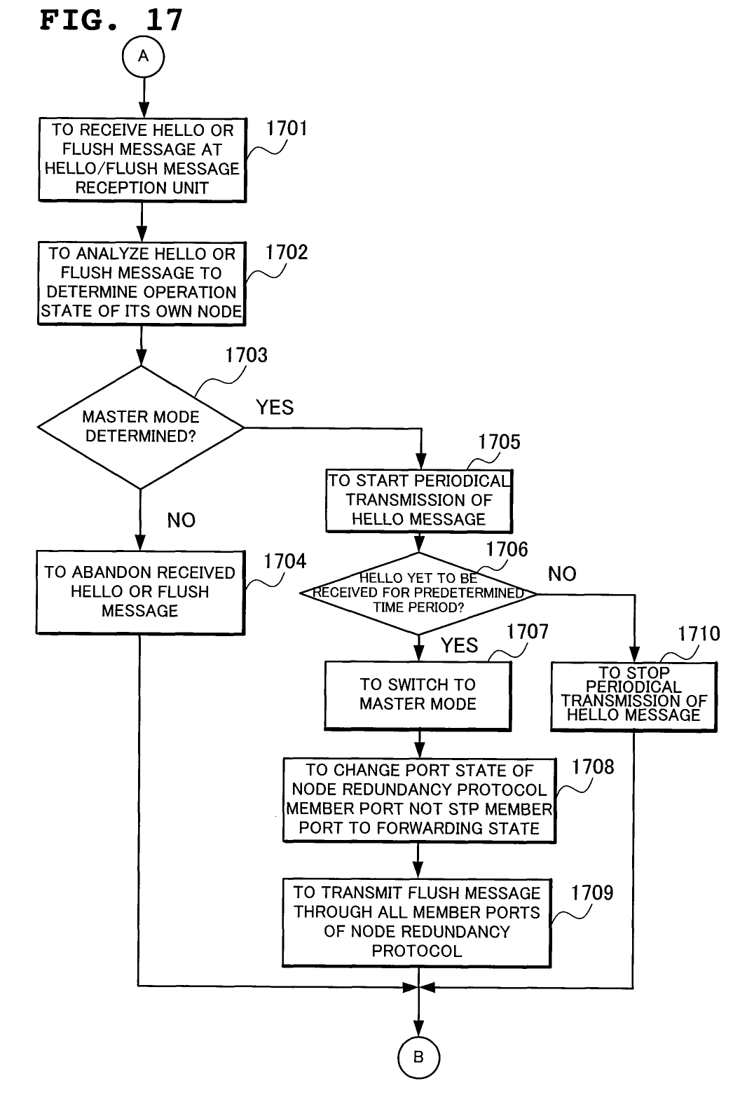

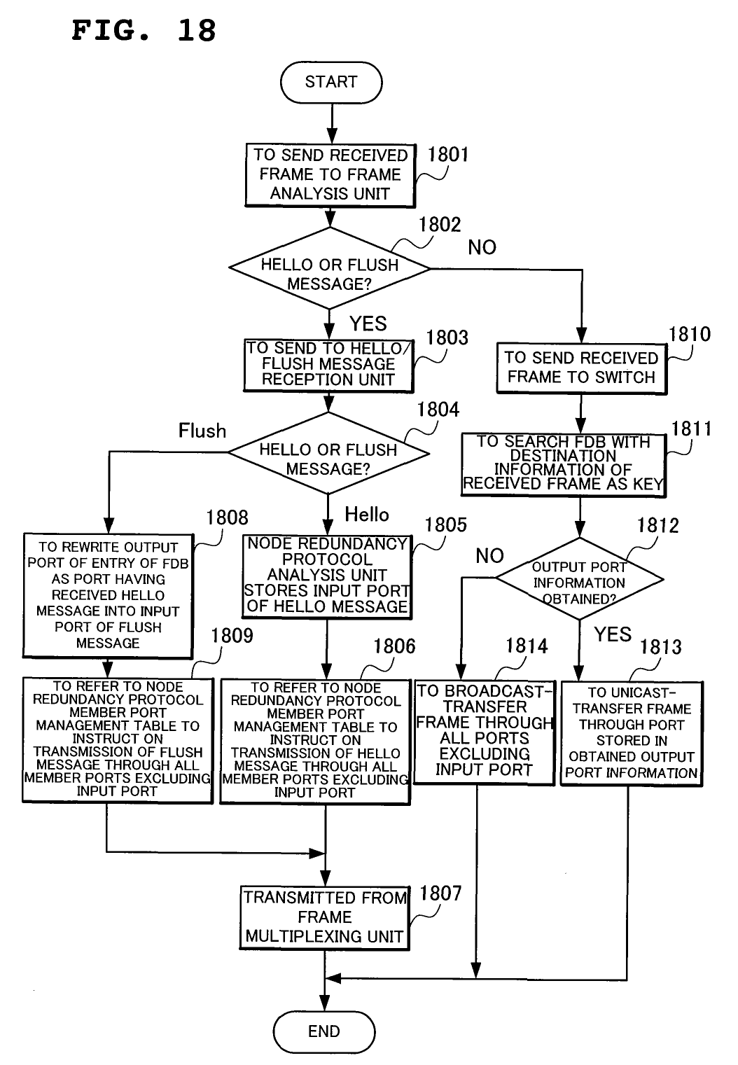

First, description will be made of a case where the operation state of the master node 10 is in the master mode with reference to the flow chart shown in FIG. 16.

Upon receiving a Hello message or the Flush message at the Hello/Flush message reception unit 171 (Step 1601), the node redundancy protocol analysis unit 172 analyzes information related to the node redundancy protocol which is stored in the received Hello message or Flush message and information related to the node redundancy protocol which is held by the node redundancy protocol analysis unit 172 itself to determine an operation state of its own node (Step 1602).

When the operation state of its own node remains unchanged in the master mode (Step 1603), abandon the received Hello message or Flush message (Step 1604) and complete processing related to the received Hello message or Flush message to successively transmit the Hello message periodically.

On the other hand, when the operation state of its own node is determined to be in the backup mode (Step 1603), the node redundancy protocol analysis unit 172 switches the operation state to the backup mode and change the port states of only the member ports (P1, P2) of the node redundancy protocol not included in the member ports of the STP from the forwarding state to the blocking state to change the contents of the port state management table 130 in order to prevent contention between the STP and the node redundancy protocol (Step 1605), as well as stopping processing of periodically transmitting the above Hello message (Step 1606).

Thereafter, as will be described later, monitor a Hello message periodically transmitted from another node in the master mode.

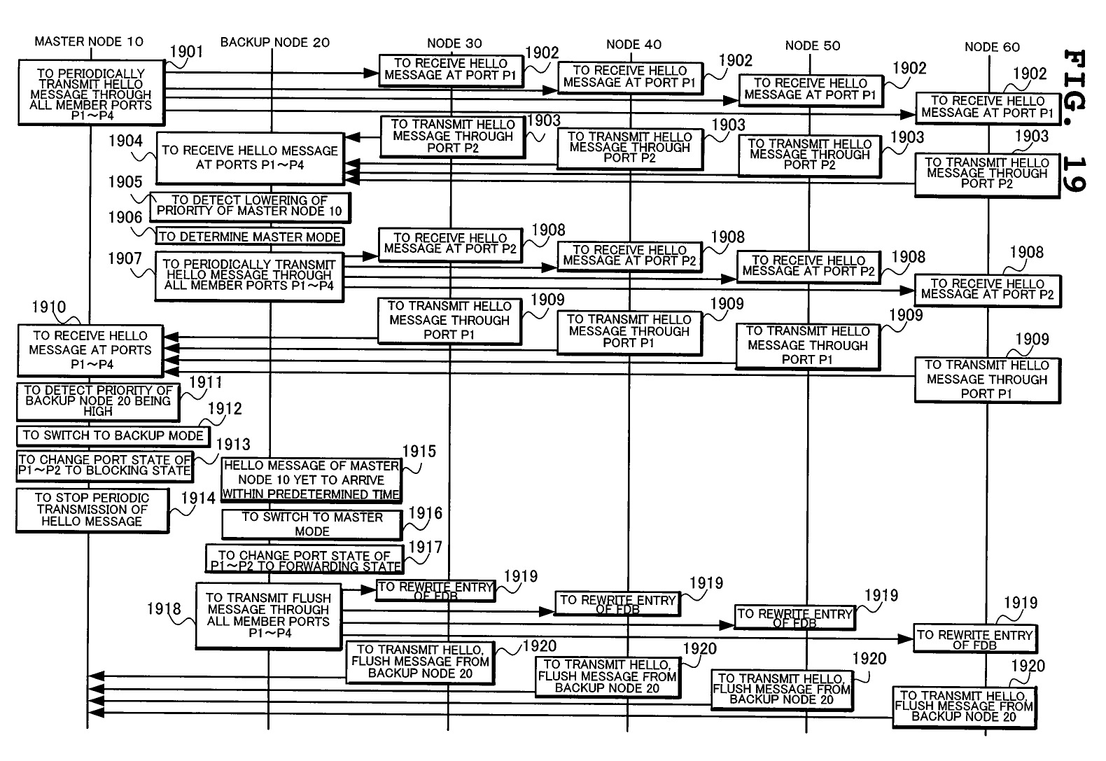

Next, description will be made of a case where the operation state of the master node 10 is in the backup mode with reference to the flow chart shown in FIG. 17.

In a case where the operation state of the master node 10 is in the backup mode, upon reception of a Hello message or a Flush message at the Hello/Flush message reception unit 171 (Step 1701), the node redundancy protocol analysis unit 172 determines an operation state of the master node 10 by analyzing information related to the node redundancy protocol which is stored in the received Hello message or Flush message and information related to the node redundancy protocol which is held by the node redundancy protocol analysis unit 172 itself (Step 1702).

When the operation state of the master node 10 remains unchanged in the backup mode (Step 1703), abandon the received Hello message or Flush message (Step 1704) to successively monitor the Hello message periodically transmitted.

When the operation state of the master node 10 is determined to be in the master mode (YES at Step 1703), the node redundancy protocol analysis unit 172 starts processing of periodically transmitting a Hello message through the member ports P1˜P4 of the node redundancy protocol (Step 1705), as well as successively monitoring the Hello message transmitted from the node (backup node 20) in the master mode.

On the other hand, the node (backup node 20) in the master mode updates the operation state of its own node from the master mode to the backup mode by receiving the Hello message periodically transmitted from the master node 10 to stop the processing of periodically transmitting a Hello message, so that the master node 10 is allowed to receive no Hello message.

When failing to receive the Hello message transmitted from the node in the master mode for a predetermined time period after start of Hello message transmission (Step 1706), the master node 10 switches the operation state of its own node to the master mode (Step 1707).

Then, in order to prevent contention between the STP and the node redundancy protocol, the master node 10 changes the port state of only the member ports (P1, P2) of the node redundancy protocol not included in the member ports of the STP from the blocking state to the forwarding state to change the contents of the port state management table 130 (Step 1708), as well as transmitting a Flush message through all the member ports of the node redundancy protocol (P1˜4) (Step 1709).

Thereafter, the master node 10 successively transmits a Hello message through the member ports P1˜P4 of the node redundancy protocol.

When the master node 10 receives a Hello message after the start of Hello message transmission, the master node 10 stops the processing of periodically transmitting a Hello message (Step 1710) and executes the above processing of analyzing, as to the received Hello message, the information related to the node redundancy protocol to determine an operation state of its own node. Operation of the master node 10 to be executed hereafter is as that described above.

In the following, description will be made of operation executed when the backup node 20 in the master mode goes down to prevent the master node 10 in the backup mode from receiving a Hello message.

When the master node 10 fails to receive a Hello message a predetermined number of times in succession, determination is made that the node (backup node 20) in the master mode goes down to start the processing of transmitting a Hello message through the member ports (P1˜P4) of the node redundancy protocol.

The master node 10 switches the operation state of its own node to the master mode when failing to receive the Hello message transmitted from the backup node 20 for a predetermined time period after the start of the Hello message transmission.

Since operation to be executed hereafter is the same as the above-described operation executed when the master node 10 switches from the backup mode to the master mode, no description will be made thereof.

Although only the operation of the master node 10 has been described in detail in the foregoing, since operation of the backup node 20 is the same as that of the master node 10 except that when the operation state of the master node 10 is in the master mode, the operation state of the backup node 20 is in the backup mode and when the operation state of the master node 10 is in the backup mode, the operation state of the backup node 20 is in the master mode, no description will be made thereof.

As described in the foregoing, the node redundancy protocol analysis unit 172 manages a port state of only a member port of the node redundancy protocol not included in the member ports of the STP and at the switching from the backup mode to the master mode, transmits a Flush message through all the member ports of the node redundancy protocol to make nodes in the STP network be redundant by the node redundancy protocol, thereby providing a network system which enables, even when one of redundant nodes goes down, communication to be continued via the other node.

In the following, structure and operation of the nodes 30 and 40 not belonging to the STP network which are connected to the member ports P1 and P2 of the master node 10 and the backup node 20 will be described.

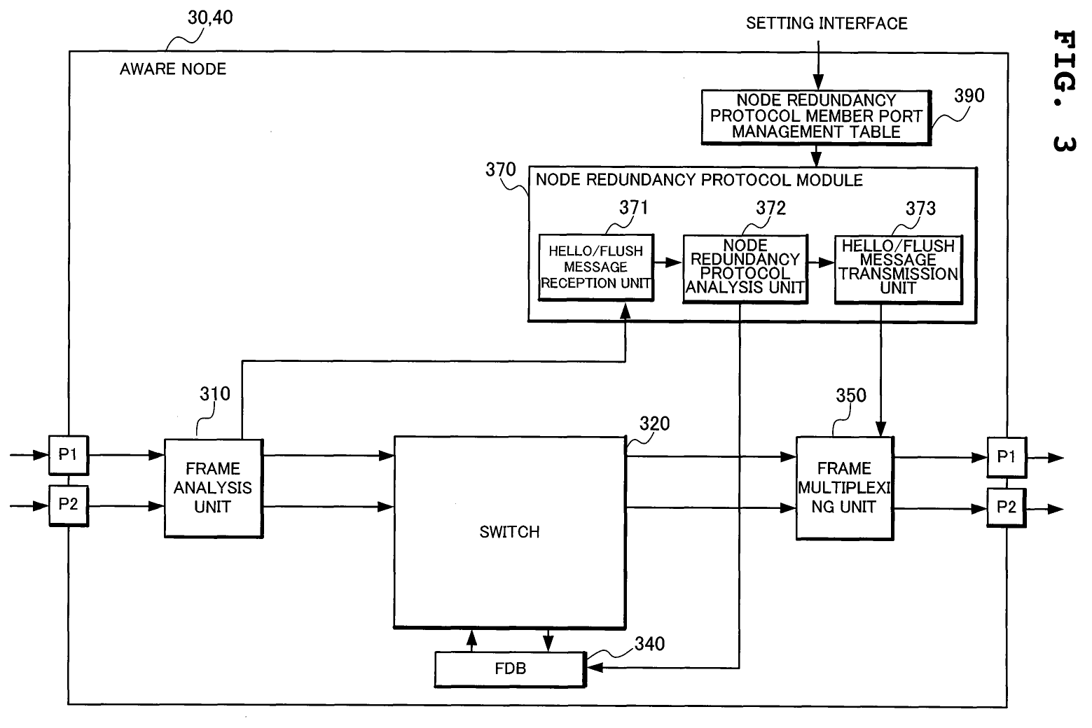

As shown in FIG. 3, the nodes 30 and 40 include a frame analysis unit 310, a switch 320, an FDB 340 and a frame multiplexing unit 350 and further include a node redundancy protocol module 370 and a node redundancy protocol member port management table 390. The node redundancy protocol module 370, similarly to the node redundancy protocol module 170 of the master node 10, includes a Hello/Flush message reception unit 371, a node redundancy protocol analysis unit 372 and a Hello/Flush message transmission unit 373.

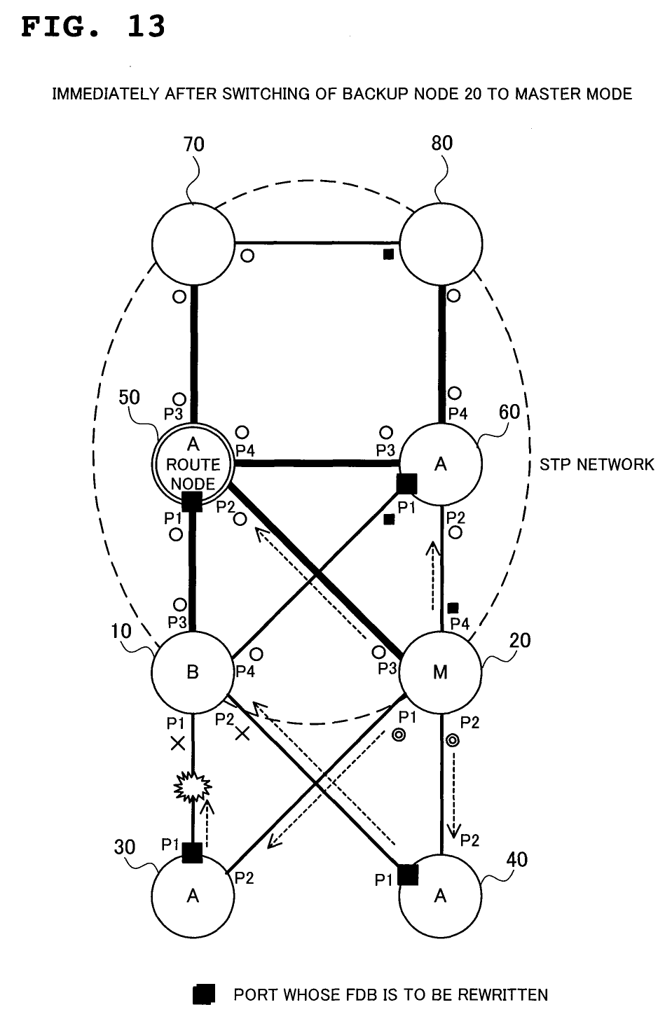

FIG. 9 shows a setting example of the node redundancy protocol member port management table 390 of the node 30 in the network structure example shown in FIG. 1.

Registered, as member ports of the node redundancy protocol of the node 30, in the node redundancy protocol member port management table 390 of the node 30 shown in FIG. 9 are the ports P1 and P2 to which the master node 10 or the backup node 20 is directly connected.

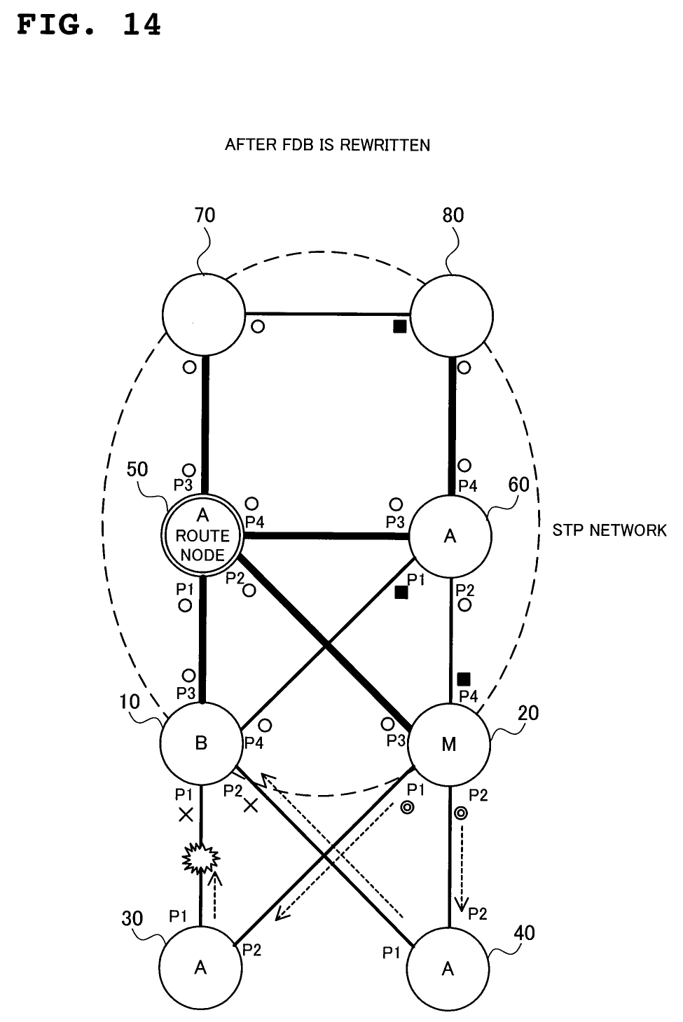

FIG. 10 shows a setting example of the node redundancy protocol member port management table 390 of the node 40 in the network structure example shown in FIG. 1.

Registered, as member ports of the node redundancy protocol of the node 40, in the node redundancy protocol member port management table 390 of the node 40 shown in FIG. 10 are the ports P1 and P2 to which the master node 10 or the backup node 20 is directly connected.

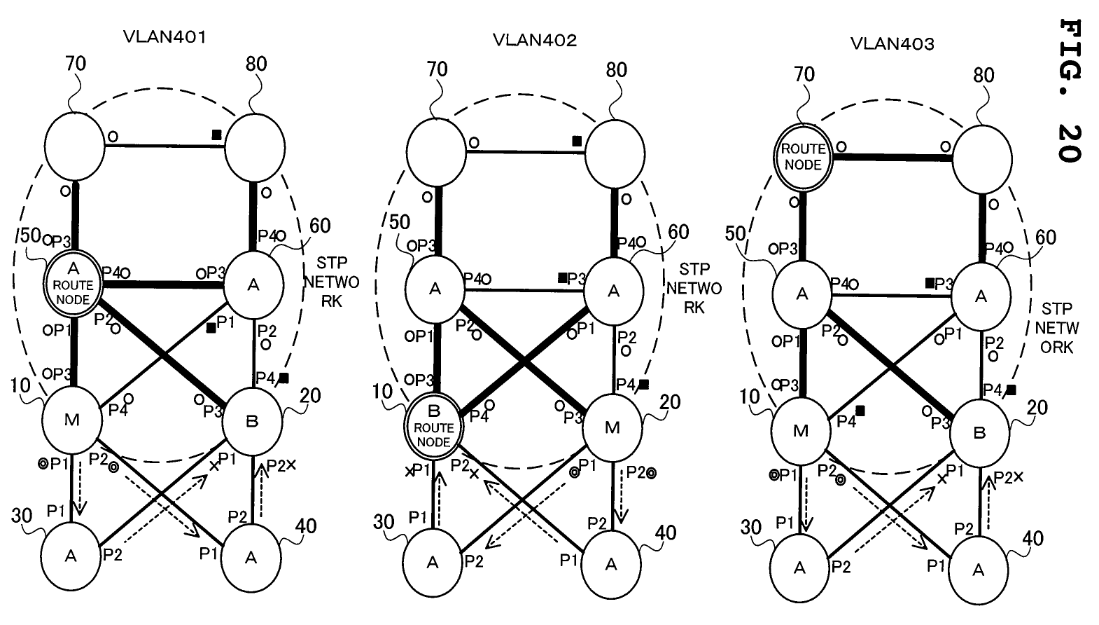

In the following, description will be made of operation executed when the node 30 receives a frame with reference to the flow chart shown in FIG. 18.

Although operation of the node 30 will be described here, since operation of the node 40 is the same as that of the node 30, no description will be made thereof.

All the frames received at the ports P1 and P2 are sent to the frame analysis unit 310 (Step 1801).

When the received frame is a Hello message or a Flush message as a control frame of the node redundancy protocol (Step 1802), the frame analysis unit 310 sends the received frame to the Hello/Flush message reception unit 371 in the node redundancy protocol module 370 (Step 1803).

When the frame received at the Hello/Flush message reception unit 371 is a Hello message (Step 1804), the node redundancy protocol analysis unit 372 stores an input port of the Hello message (Step 1805), as well as referring to the node redundancy protocol member port management table 390 to instruct the Hello/Flush message transmission unit 373 to transmit the received Hello message through all the member ports of the node redundancy protocol excluding the input port (Step 1806).

When no relevant port is registered in the node redundancy protocol member port management table 390, the Hello message is transmitted through all the ports other than the input port.

The received Hello message is sent from the Hello/Flush message transmission unit 373 to the frame multiplexing unit 350 and transmitted through a port instructed by the node redundancy protocol analysis unit 372 together with output port information (Step 1807).

When the frame received at the Hello/Flush message reception unit 371 is a Flush message (Step 1804), the node redundancy protocol analysis unit 372 rewrites, among the entries of the FDB 340, an output port of an entry whose output port information is a port having received the Hello message so far into an input port of the received Flush message (Step 1808), as well as referring to the node redundancy protocol member port management table 390 to instruct the Hello/Flush message transmission unit 173 to transmit the received Flush message through all the member ports of the node redundancy protocol excluding the input port (Step 1809).

In addition, when no relevant port is registered in the node redundancy protocol member port management table 390, the Flush message is transmitted through all the ports other than the input port.

The received Flush message is sent from the Hello/Flush message transmission unit 373 to the frame multiplexing unit 350 and transmitted through an output port instructed by the node redundancy protocol analysis unit 372 together with output port information (Step 1807).

Next, description will be made of a case where at Step 1802, determination is made that the received frame is an ordinary data frame other than a control frame of the node redundancy protocol.

When the frame analysis unit 310 sends the received frame to the switch 320 (Step 1810) and the switch 320 searches the FDB 340 with destination information stored in the received frame as a key (Step 1811) to obtain output port information of the received frame (Step 1812), by instructing the frame multiplexing unit 350 to transmit the received frame through a port stored in the obtained output port information, the received frame is unicast-transferred (Step 1813).

When no output port information related to the destination which is stored in the received frame is found, the switch 320 instructs the frame multiplexing unit 350 to transmit the received frame through all the ports other than the input port, thereby broadcast-transferring the received frame (Step 1814).

As described in the foregoing, the nodes 30 and 40 ordinarily transfer a Hello message periodically transmitted from a node in the master mode to a node in the backup mode and when the operation states of redundant nodes switch from each other, receive a Flush message transmitted from a node newly switching to the master mode to update the contents of the FDB 340, thereby enabling communication to be continued even when a network failure occurs such as link cut-off or node down to change the node in the master mode.

In the following, description will be made of structure and operation of the nodes 50 and 60 belonging to the STP network which are connected to the member ports P3 and P4 of the master node 10 and the backup node 20.

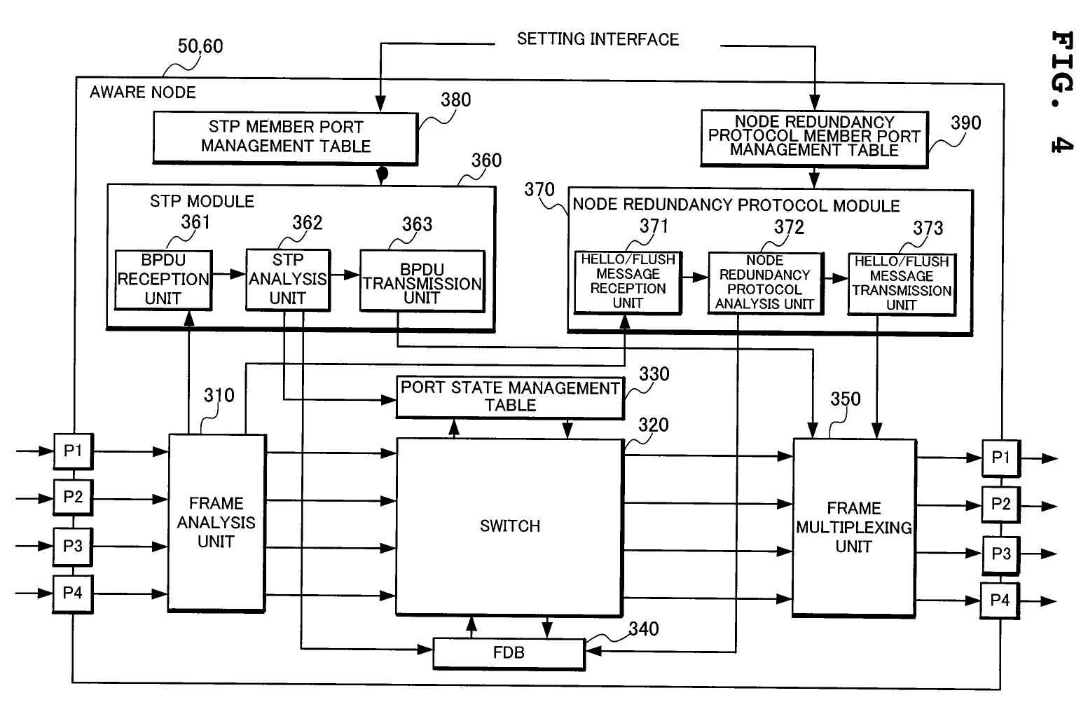

As shown in FIG. 4, the nodes 50 and 60 belonging to the STP network include, in addition to the components of the nodes 30 and 40 shown in FIG. 3, an STP module 360, an STP member port management table 380 and a port state management table 330.

The STP module 360 of the nodes 50 and 60, similarly to the STP module 160 of the master node 10 and the backup node 20, includes a BPDU reception unit 361, an STP analysis unit 362 and a BPDU transmission unit 363.

FIG. 11 shows a setting example of the node redundancy protocol member port management table 390 and a setting example of the STP member port management table 380 of the node 50 in the network structure example shown in FIG. 1.

Registered in the node redundancy protocol member port management table 390 of the node 50 shown in FIG. 11 are the ports P1 and P2 to which the master node 10 or the backup node 20 is directly connected as member ports of the node redundancy protocol of the node 50.

In addition, registered in the STP member port management table 380 of the node 50 shown in FIG. 11 are the ports P1˜4 to which the nodes 10, 20, 60 and 70 forming the STP network are directly connected as member ports of the STP of the node 50.

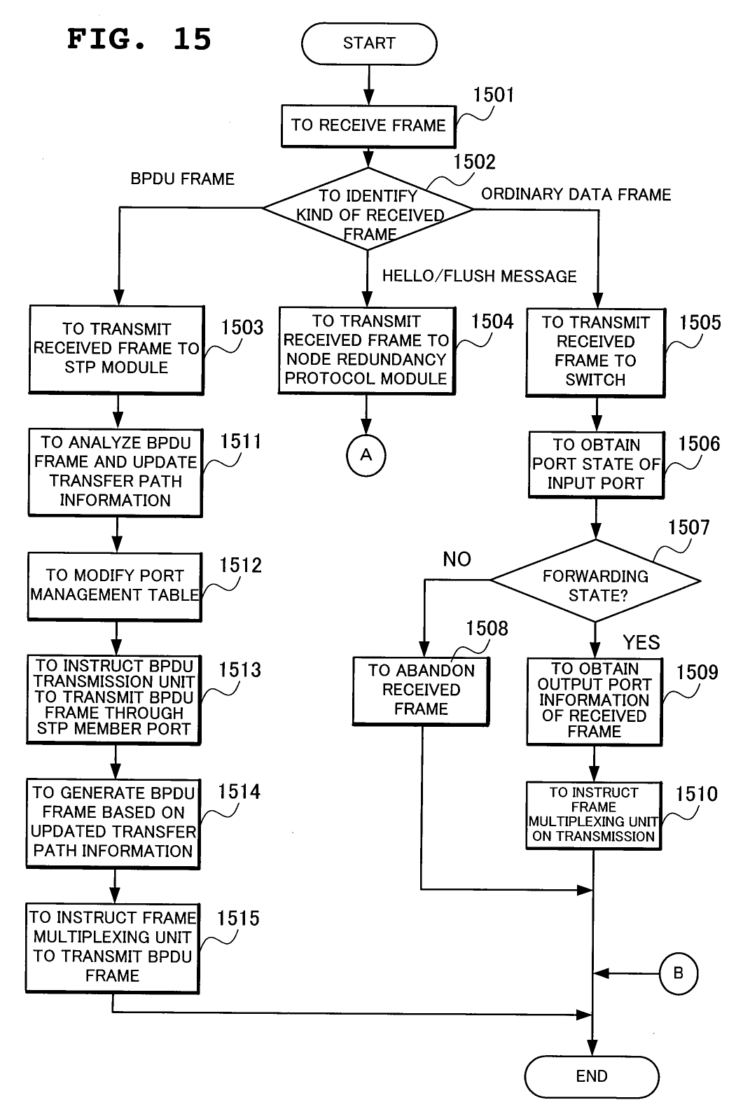

FIG. 12 shows a setting example of the node redundancy protocol member port management table 390 and a setting example of the STP member port management table 380 of the node 60 in the network structure example shown in FIG. 1.

Registered in the node redundancy protocol member port management table 390 of the node 60 shown in FIG. 12 are the ports P1 and P2 to which the master node 10 or the backup node 20 is connected as member ports of the node redundancy protocol of the node 60.

In addition, registered in the STP member port management table 380 of the node 60 shown in FIG. 12 are the ports P1˜4 to which the nodes 10, 20, 50 and 80 forming the STP network are directly connected as member ports of the STP of the node 60.

In the following, operation executed when the node 50 receives a frame will be described.

Although the description will be here made of operation of the node 50, since operation of the node 60 is the same as that of the node 50, no detailed description will be made thereof.

All the frames received at the ports P1 and P2 are sent to the frame analysis unit 310.

The frame analysis unit 310 identifies a kind of the received frame and when the received frame is a BPDU frame as a control frame of the STP, sends the received frame to the BPDU reception unit 361 in the STP module 360.

Since operation of the STP module 360 executed hereafter is the same as the operation of the STP module 160 executed when the master node 10 receives a BPDU frame, no description will be made thereof.

When a received frame is a Hello message or a Flush message as a control frame of the node redundancy protocol, the frame analysis unit 310 sends the received frame to the Hello/Flush message reception unit 371 in the node redundancy protocol module 370.

Since operation of the node redundancy protocol module 370 executed hereafter is the same as the operation of the node redundancy protocol module 370 executed when the node 30 receives a Hello message or a Flush message, no description will be made thereof.

When the received frame is an ordinary data frame other than a control frame of the node redundancy protocol, the frame analysis unit 310 sends the received frame to the switch 320.

Since operation of transferring a data frame which is executed hereafter is the same as the above-described operation of transferring a data frame by the master node 10, no description will be made thereof.

As described in the foregoing, the node 50, similarly to the node 30, ordinarily transfers a Hello message periodically transmitted from a node in the master mode to a node in the backup mode and when operation states of redundant nodes switch from each other, receives a Flush message transmitted from a node newly switching to the master mode to update the contents of the FDB 304, thereby enabling communication to be continued even when the node in the master mode is changed due to a network failure such as link cut-off or node down.

Next, operation of the network system according to the first embodiment will be described with reference to the sequence chart shown in FIG. 19.

Assume that in the network structure shown in FIG. 1, the operation state of the master node 10 is in the master mode and the operation state of the backup node 20 is in the backup mode.

In an ordinary state, the master node 10 periodically transmits a Hello message through all the member ports (P1˜P4) registered in the redundancy protocol member port management table 190 (1901).

The nodes 30, 40, 50 and 60 receive a Hello message at their ports P1 which is transmitted from the master node 10 (1902) and transmit the received Hello message through the ports P2 to which the backup node 20 is connected (1903).

The backup node 20 receives the Hello message periodically transmitted from the master node 10 (1904) to monitor information related to the node redundancy protocol stored in the Hello message.

Description will be here made of a case where a link between the master node 10 and the node 30 is cut off, so that priority of the master node 10 becomes lower than priority of the backup node 20.

Upon detecting the priority of the master node 10 which is stored in the Hello message received at the port P2 going lower than the priority of the backup node 20 (1905), the backup node 20 has its operation state determined to be in the master mode (1906) to periodically transmit a Hello message through the member ports (P1˜P4) of the node redundancy protocol (1907).

The nodes 30, 40, 50 and 60 transmit the Hello message transmitted from the master node 10 to the backup node 20, as well as receiving the Hello message transmitted from the backup node 20 (1908) to transmit the same to the master node 10 (1909).

Upon receiving the Hello message transmitted from the backup node 20 (1910), the master node 10 detects the priority of the backup node 20 stored in the Hello message going higher than that of its own node (1911) to switch the operation state of its own node from the master mode to the backup mode (1912).

More specifically, as to the port state management table 130 of the master node 10, change a port state of the node redundancy protocol member ports (P1, P2) not included in the STP member port management table 180 from the forwarding state to the blocking state (1913).

Then, the master node 10 stops the processing of periodically transmitting a Hello message (1914) and hereafter monitors a Hello message periodically transmitted from the backup node 20.

On the other hand, when failing to receive a Hello message transmitted from the master node 10 for a predetermined time period after the start of Hello message transmission (1915), the backup node 20 switches the operation state of its own node to the master mode (1916).

More specifically, as to the port state management table 130 of the backup node 20, change a port state of the node redundancy protocol member ports (P1, P2) not included in the STP member port management table 180 from the blocking state to the forwarding state (1917).

Then, the backup node 20 transmits a Flush message through the member ports (P1˜P4) of the node redundancy protocol (1918) and hereafter periodically transmits a Hello message.

The nodes 30, 40, 50 and 60 respectively receive a Flush message at the port P2 which is transmitted from the backup node 20 and among entries of the FDB, rewrite an output port of an entry whose output port information is the port P1 having received a Hello message into the port P2 receiving a Flush message (1919). In addition, transmit a Hello message and a Flush message transmitted from the backup node 20 to the master node 10 (1920).

FIG. 13 shows a state of a network as of immediately after change of the FDB of the Aware node after the operation state of the backup node 20 is switched from the backup mode to the master mode to transmit a Flush message from the backup node 20.

FIG. 14 shows a network in a state where the operation states of the master node 10 and the backup node 20 are switched to periodically transmit a Hello message from the backup node 20.

As described above, according to the first embodiment of the present invention, the node is structured such that a port state of a port as a member port of the node redundancy protocol and also as a member port of the STP is managed not by the node redundancy protocol module 170 but only by the STP module 160 and such that when the operation states of the master node 10 and the backup node 20 switch, a Flush message is transmitted from all the member ports of the node redundancy protocol, thereby preventing occurrence of contention related to member ports between the node redundancy protocol and the STP to enable application of the node redundancy protocol to the node in the STP network.

### Second Embodiment

Next, a network system according to a second embodiment of the present invention will be described.

In the second embodiment, description will be made of a method of applying the node redundancy protocol of the present invention to a network system in which a plurality of VLAN (Virtual LAN) are set.

FIG. 20 is an example of application of the node redundancy protocol of the present invention to a network system in which three VLAN 401, 402 and 403 are set, which shows a state of the network system for each VLAN.

In the VLAN 401, the node 50 is a route node of the STP network and the operation states of the master node 10 and the backup node 20 are in the master mode and the backup mode, respectively.

In the VLAN 402, the master node 10 is a route node of the STP network and the operation states of the master node 10 and the backup node 20 are in the backup mode and the master mode, respectively.

In the VLAN 403, the node 70 is a route node of the STP network and the operation states of the master node 10 and the backup node 20 are in the master mode and the backup mode, respectively.

As described in the foregoing, the route node of the STP network may vary with each VLAN and operation states of the node redundancy protocol in the master node 10 and the backup node 20 may vary with each VLAN.

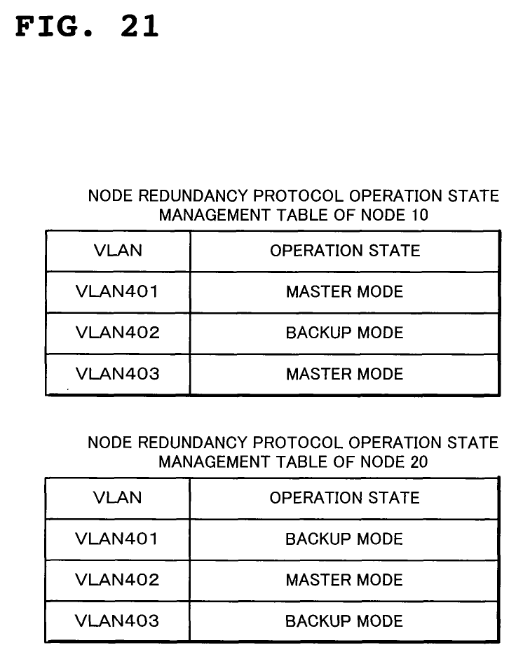

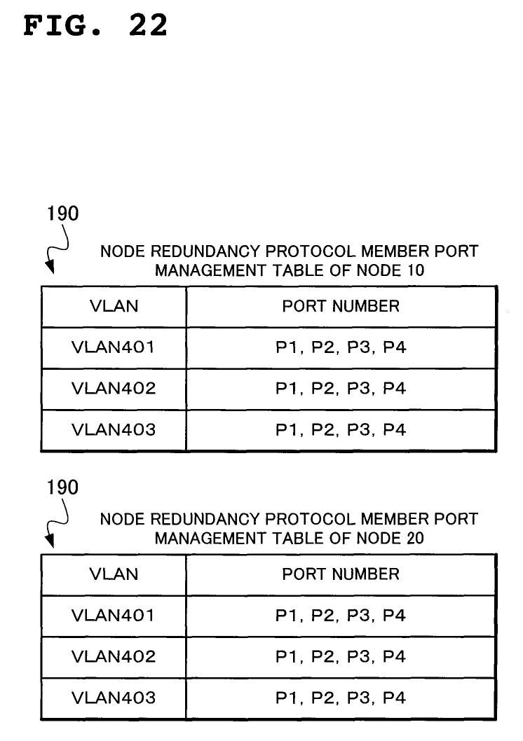

FIG. 21 shows an operation state of the node redundancy protocol at the VLAN 401, 402 and 403 of the master node 10 and the backup node 20.

The node redundancy protocol analysis unit 172 of the master node 10 and the backup node 20 holds the contents shown in FIG. 21.

In other words, while in the first embodiment, the node redundancy protocol analysis unit 172 holds only one operation state of the node redundancy protocol of its own node, in the second embodiment, it holds an operation state of the node redundancy protocol of its own node for each VLAN.

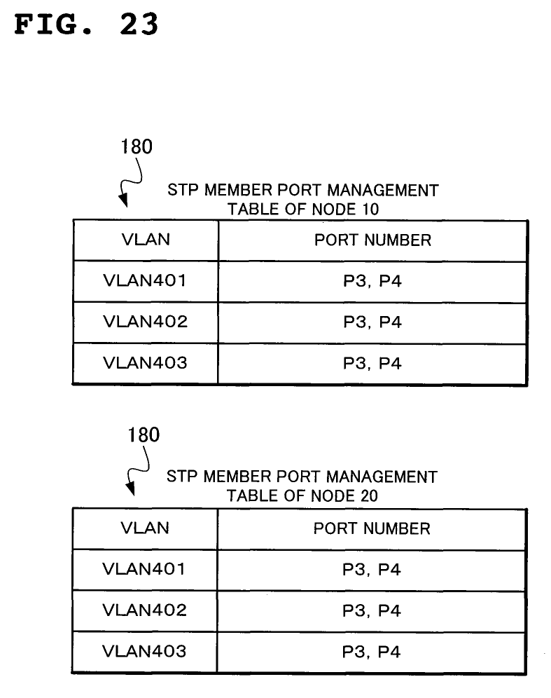

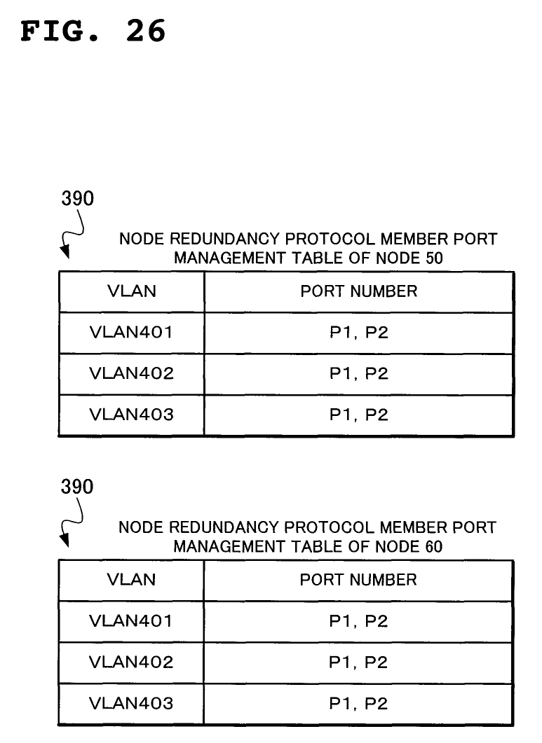

Like the node redundancy protocol member port management table 190 of the master node 10 and the backup node 20 shown in FIG. 22, the node redundancy protocol member port management table of the nodes 30 and 40 shown in FIG. 25 and the node redundancy protocol member port management table of the nodes 50 and 60 shown in FIG. 26, member ports of the node redundancy protocol are managed for each VLAN in the present embodiment.

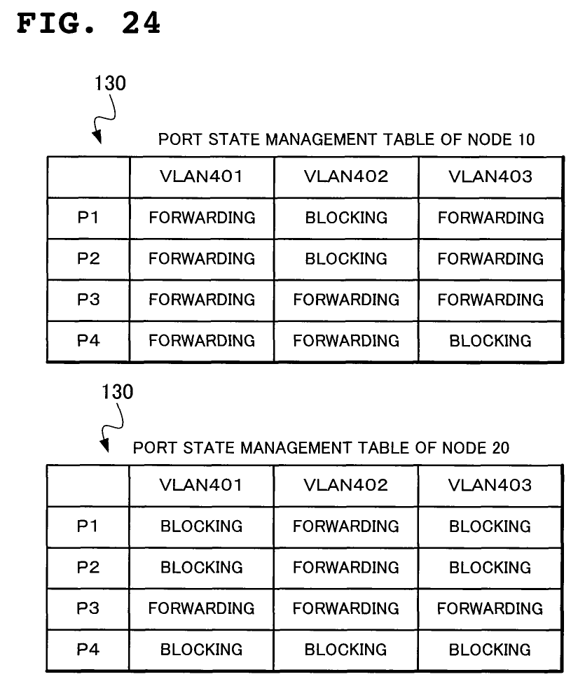

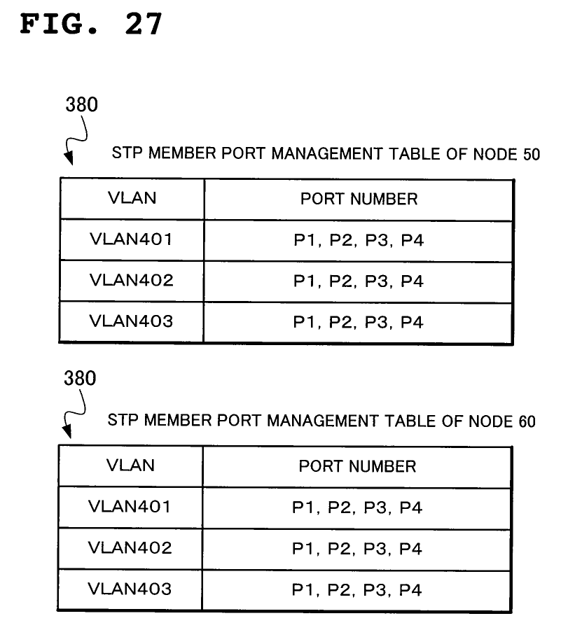

Similarly, like the STP member port management table 180 of the master node 10 and the backup node 20 shown in FIG. 23 and the STP member port management table of the nodes 50 and 60 shown in FIG. 27, a member port of the STP is managed for each VLAN in the present embodiment.

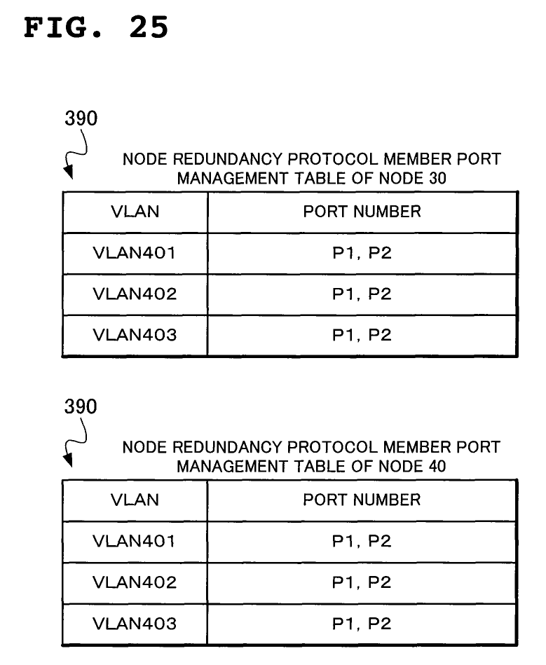

Like the port state management table 130 of the master node 10 and the backup node 20 shown in FIG. 24, a port state of each port is managed for each VLAN in the present embodiment.

Structure of the master node 10, the backup node 20 and the nodes 30 and 40, and the nodes 50 and 60 is the same as the structure described in the first embodiment except that each of the above-described information is managed for each VLAN and that the FDB 140 stores a destination and a correspondence between information of VLAN and output port information.

The master node 10 and the backup node 20 manage a port state of a member port for each of the VLAN 401, 402 and 403 by the system described in the first embodiment.

Operation in each VLAN of the master node 10 and the backup node 20 differs from the operation of the master node 10 and the backup node 20 described in the first embodiment in referring to VLAN information.

In the second embodiment, the master node 10 and the backup node 20 transmit a Hello message or a Flush message with an ID (VRID) for identifying a VLAN stored.

In addition, when the master node 10 and the backup node 20 receive a Hello message or a Flush message, reference is made to the VRID stored in the Hello message or the Flush message to determine, as to a VLAN corresponding to the VRID, an operation state of the node redundancy protocol (master mode or backup mode) and a port state of a member port of the node redundancy protocol (forwarding state or blocking state).

Although in a case, for example, where the backup node 20 receives a Hello message with a VRID1 corresponding to the VLAN 401 stored, the backup node 20 executes the above-described processing with respect to an operation state of the node redundancy protocol and a port state of a member port of the node redundancy protocol in the VLAN 401, the operation state and the port state of the member port of the node redundancy protocol in the VLAN 402 and 403 will not be affected.

In addition, as to a BPDU frame, a transfer path of the STP network is calculated for each VLAN to manage a port state of a member port of the STP for each VLAN by ref erring to VLAN information (e.g. VLAN ID stored in a VLAN tag) stored in the frame.

In addition, as to a BPDU frame and a data frame other than a Hello message and a Flush message, the switch 120 searches the FDB 140 with destination information and VLAN information stored in the frame as a key to obtain output port information, thereby transferring the received frame.

Operation executed when receiving a Hello message or a Flush message of the Aware nodes (nodes 30, 40, 50, 60), similarly to the master node 10 and the backup node 20, is the same as the operation described in the first embodiment except that a VRID stored in a Hello message or a Flush message is referred to to execute processing of the node redundancy protocol with respect to a VLAN corresponding to the VRID.

When the Aware node receives a Flush message, for example, a VRID stored in the Flush message is referred to to rewrite, among entries of the FDB 304, output port information of an entry whose VLAN information is VLAN corresponding to the VRID and whose output port information is a port having received a Hello message in which the same VRID is stored before the reception of the Flush message into a reception port of the Flush message.

In addition, operation of the Aware node executed at the reception of a BPDU frame and a data frame is the same as that of the master node 10 and the backup node 20 described above.

As described above, by managing an operation state of the node redundancy protocol for each VLAN by the STP member port management table 180, the node redundancy protocol member port management table 190 and the port state management table 130, as well as transmitting a Hello message or a Flush message with an ID (VRID) for identifying a VLAN stored by the master node 10 and the backup node 20, the node redundancy protocol of the present invention can be applied to a network system where a plurality of VLAN are set.

### Third Embodiment

Next, a network system according to a third embodiment of the present invention will be described.

As to a node redundancy protocol according to the third embodiment, description will be made of a method which enables a node in an STP network be redundant without making improvement of a node adapted to an existing STP even a structure in which the nodes 50 and 60 of FIG. 1 include only the STP module 360 similarly to a node provided in an ordinary STP network.

Since when a node adapted to an existing STP is used as the nodes 50 and 60 in FIG. 1 and the node redundancy protocol according to the first embodiment is applied to the network system of FIG. 1, the node adapted to an existing STP is not allowed to recognize a control frame (Hello message or a Flush message) of the node redundancy protocol, there occurs a problem that the node is not allowed to function as an Aware node of the node redundancy protocol. 5 More specifically, there is a problem that a Hello message transmitted from one node (one of the master node 10 and the backup node 20) of paired nodes to which the node redundancy protocol is applied can not be transferred to other node.

In addition, another problem is that when the operation states of the master node 10 and the backup node 20 switch, a Flush message transmitted from a node switching from the backup mode to the master mode can not be recognized to disable rewriting of the FDB, thereby interrupting communication until an entry of the FDB is aged.

By using a special address as destination information stored in a Hello message and using a BPDU frame as a Flush message transmitted to the Aware nodes 50 and 60 belonging to the STP network, the third embodiment enables a node adapted to an existing STP, even when it fails to recognize a control frame of the node redundancy protocol, to function as an Aware node.

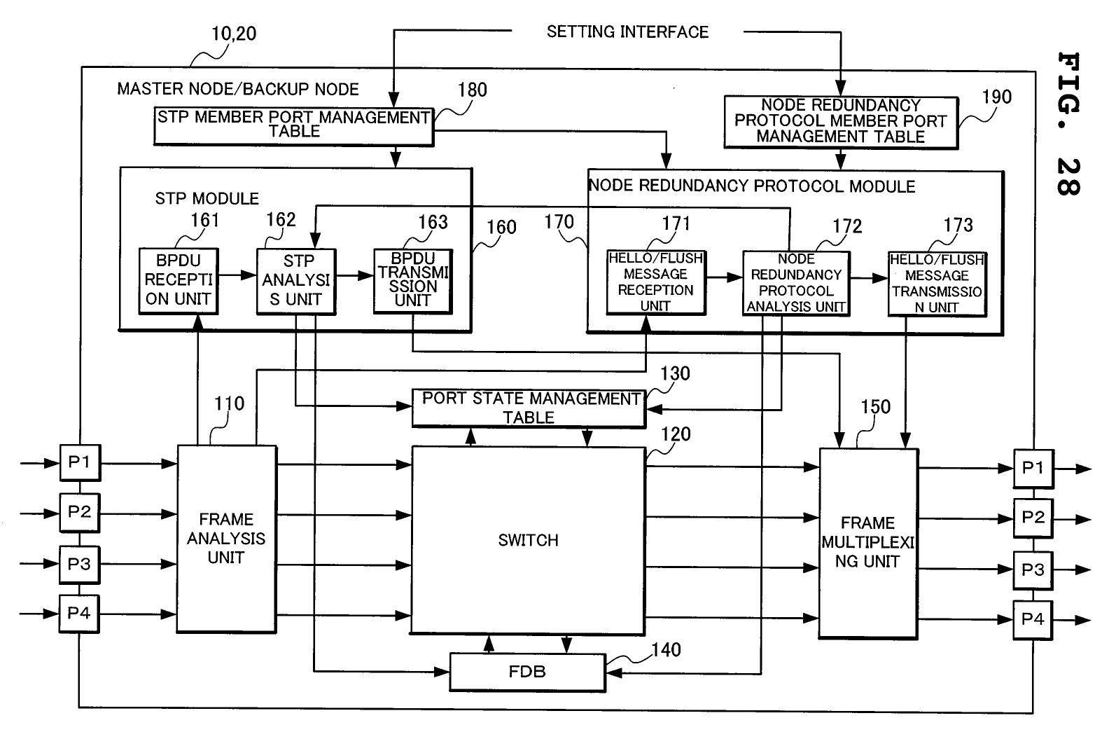

Although structure of the master node 10 and the backup node 20 is basically the same as that shown in the first embodiment, the third embodiment has an additional function of the node redundancy protocol analysis unit 172 of the node redundancy protocol module 170 to instruct the STP analysis unit 162 of the STP module 160 to transmit a BPDU frame with a Topology Change flag of the STP set up which is used as a Flush message to the nodes 30, 40 as shown in FIG. 28.

First, description will be made of a method by which the nodes 50 and 60 adapted to an existing STP enable transfer of a Hello message and a Flush message in the following.

In the third embodiment, the master node 10 and the backup node 20 transmit a Hello message or a Flush message with a special address which is always determined to be unknown by a node adapted to an existing STP stored as destination information.

The frame analysis unit 110 of the master node 10 and the backup node 20 and the frame analysis unit 310 of the Aware nodes 30 and 40 not belonging to the STP network are set to recognize a frame having the special address as destination information as a control frame (a Hello message and a Flush message) of the node redundancy protocol.

This arrangement enables a Hello message and a Flush message transmitted from one of the master node 10 and the backup node 20 to the nodes 30 and 40 to be transferred to the other node in the same manner as that of the first embodiment.

On the other hand, when the nodes 50 and 60 receive a Hello message and a Flush message, the frame analysis unit 310 recognizes the messages not as control frames of the node redundancy protocol but as ordinary data frames and transfers the Hello message and the Flush message to the switch 320.

Although the switch 320 of the nodes 50 and 60 searches the FDB 340 with the destination information of the Hello message and the Flush message as a key, because a special address is used as the destination information of the Hello message and the Flush message, search will always fail.

Therefore, the switch 320 broadcast-transfers the received Hello message or the Flush message through all the ports other than a port having received the Hello message or the Flush message which is in the forwarding state among member ports of the STP.

Since any of the member ports of the STP of the nodes 50 and 60 is connected to the master node 10 and the backup node 20, a Hello message or a Flush message transmitted from one of the master node 10 and the backup node 20 can be transferred to other node.

At this time, by storing an ID for identifying a node pair (the master node 10 and the backup node 20) which has transmitted the Hello message or the Flush message in the Hello message and the Flush message, erroneous operation of the master node 10 and the backup node 20 can be prevented which is caused by reception of a Hello message or a Flush message transmitted from other node pair and broadcast-transferred within the STP network.

In addition, as another method of solving the problem that transfer of a Hello message is disabled when the Aware nodes 50 and 60 are nodes adapted to an existing STP, possible is refraining transmission of a Hello message to a port among the member ports of the node redundancy protocol of the master node 10 and the backup node 20 which is also included in the member ports of the STP.

In this case, because the Hello message and the Flush message are transferred only via the Aware nodes 30 and 40 not belonging to the STP network and no Hello message is broadcast-transferred in the STP network, erroneous operation caused by a Hello message transmitted by other node pair can be prevented, while no communication band can be compressed by unnecessary traffic.

Next, description will be made of a method for enabling erase of the FDB 340 when the nodes 50 and 60 adapted to an existing STP receive a Flush message.

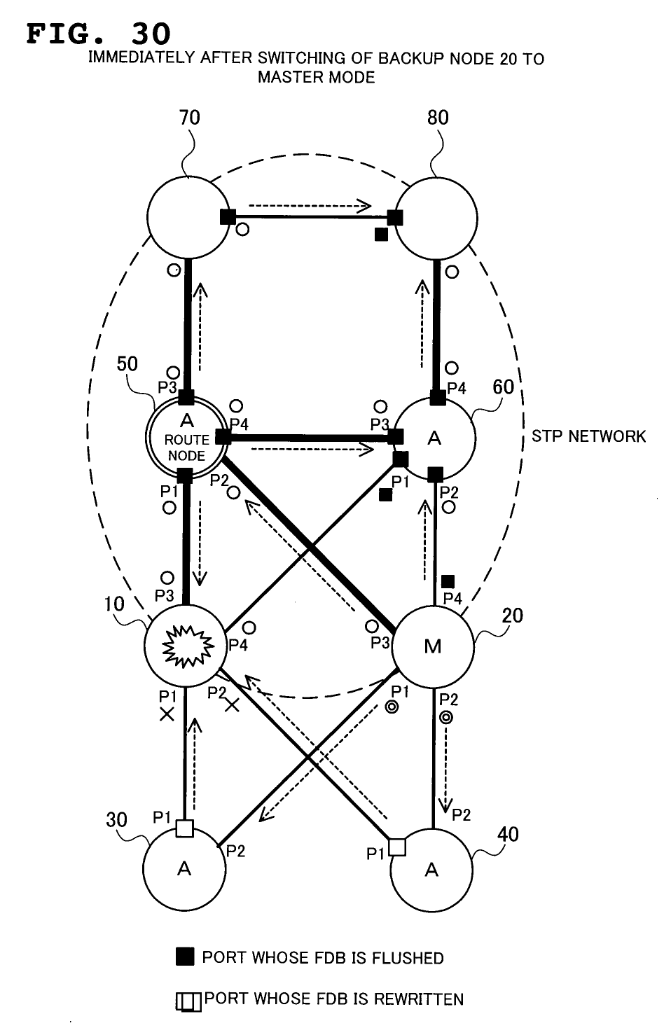

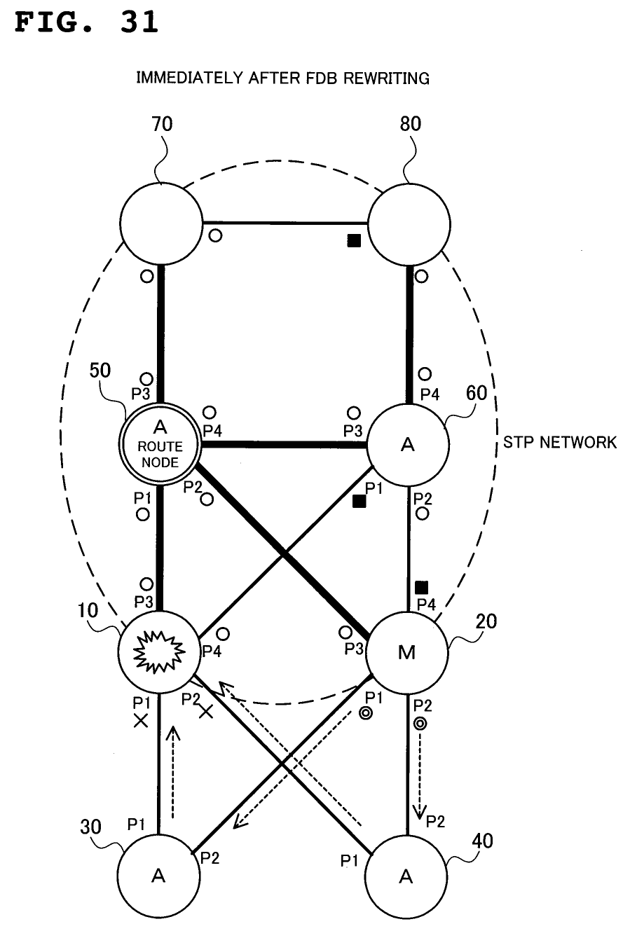

As shown in FIG. 30, when the backup node 20 switches from the backup mode to the master mode due to a failure occurring in the master node 10 in the master mode, a Flush message will be transmitted to the nodes 30 and 40 from the backup node 20 similarly to the first embodiment, so that the FDB 340 of the nodes 30 and 40 will be rewritten.

To the nodes 50 and 60 in the STP network, the node redundancy protocol analysis unit 172 of the backup node 20 instructs the STP analysis unit 162 to transmit a BPDU frame with a Topology Change flag set up to a port set both in the STP member port management table 180 and the node redundancy protocol member port management table 190 of the backup node 20.

As a result, a BPDU frame with a Topology Change flag set up is transmitted from the BPDU transmission unit 163 to a member of the STP.

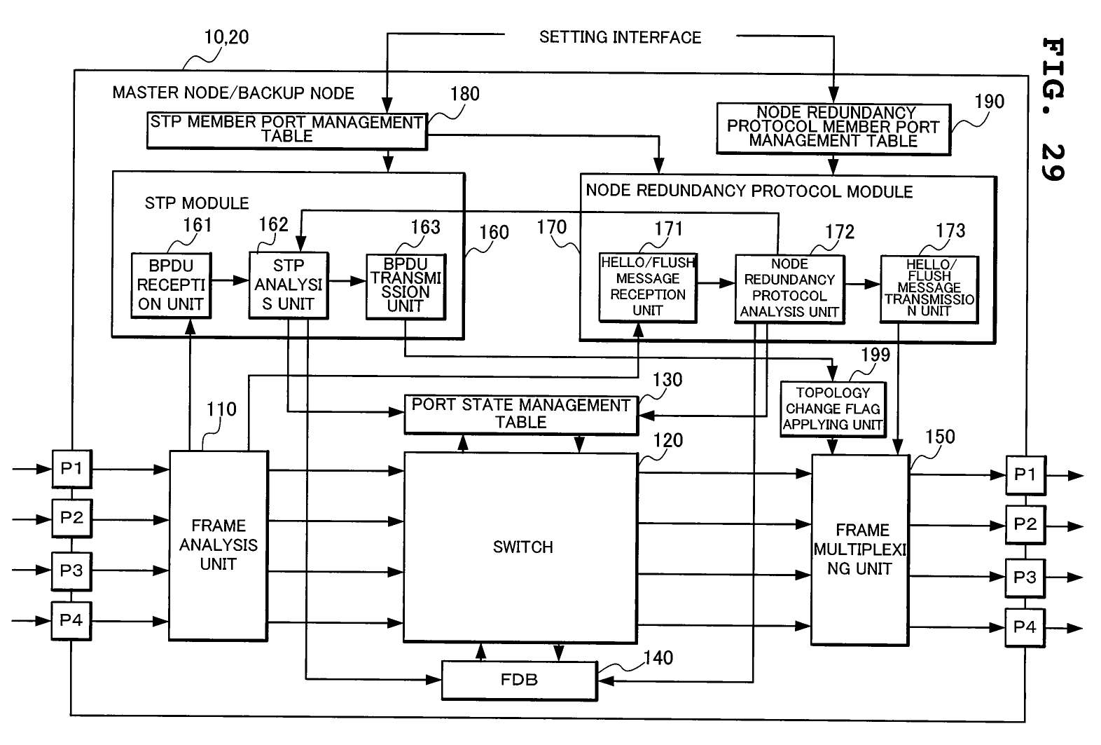

In addition, among methods of transmitting a BPDU frame with a Topology Change flag set up is providing a Topology Change flag applying unit 199 between the BPDU transmission unit 163 and the frame multiplexing unit 150 as shown in the structure of the master node 10 and the backup node 20 in FIG. 29.

In the above-described method, instructing the Topology Change flag applying unit 199 by the node redundancy protocol analysis unit 192 to set up a Topology Change flag of a BPDU frame periodically transmitted from a BPDU transmission unit 163 enables transmission of a Flush message to a member port of the node redundancy protocol which is included in the STP member ports.

Upon receiving a BPDU frame with a Topology Change flag set up, the nodes 50 and 60 transmit the BPDU frame with a Topology Change flag set up through all the member ports of the STP other than the BPDU frame receiving port as defined in the specification of the STP, as well as erasing all the entries whose output port information is a transmission port of the BPDU frame among the entries of the FDB 340.

Since the ports through which the BPDU frame with a Topology Change flag set up are transmitted include a port (P1) to which the master node 10 is connected without fail, it is unnecessary to store a port having received a Hello message before the nodes 50 and 60 receive the BPDU frame.

As described in the foregoing, by using a BPDU frame with a Topology Change flag set up as a Flush message to the Aware node in the STP network, the node redundancy protocol of the third embodiment can be applied also to an STP network formed by nodes adapted to an existing STP.

As described in the foregoing, according to the third embodiment, arranging a Hello message to be broadcast-transferred in an STP network by the use of a special address always determined to be unknown by a node adapted to an existing STP as destination information of a Hello message and using a BPDU with a Topology Change flag set up as a Flush message to a node adapted to an existing STP enables nodes in the STP network to be made redundant without improving a node adapted to an existing STP.

### Fourth Embodiment

Next, a network system according to a fourth embodiment of the present invention will be described.

The fourth embodiment will be described with respect to a method of applying the node redundancy protocol of the present invention to a part where two STP networks are connected with each other to improve reliability of a part where the STP networks are connected with each other.

FIG. 32 shows a network system structure having an STP network 1 formed of the master node 10, the backup node 20 and the nodes 50, 60, and 70 and 80 and an STP network 2 formed of a master node 10a, a backup node 20aand nodes 90 and 100 connected with each other by four links which connect the master nodes 10 and 10a and the backup nodes 20 and 20a.

In the following, description will be made of a method of applying the node redundancy protocol according to the fourth embodiment to the network system shown in FIG. 32.

First, assume the master node 10 and the backup node 20 of the STP network 1 to be a redundant node pair and the nodes 50 and 60 of the STP network 1 and the master node 10a and the backup node 20a of the STP network 2 to be Aware nodes of the master node 10 and the backup node 20 to apply the node redundancy protocol according to the first embodiment.

Next, assume the master node 11a and the backup node 20a of the STP network 2 to be a redundant node pair and the nodes 90 and 100 of the STP network 2 and the master node 10 and the backup node 20 of the STP network 1 to be Aware nodes of the master node 10a and the backup node 20a to apply the node redundancy protocol according to the first embodiment.

At this time, the master nodes 10 and 10a and the backup nodes 20 and 20a store an ID for identifying a Hello message and a Flush message transmitted from the master node 10 and the backup node 20 and a Hello message and a Flush message transmitted from the master node 10aand the backup node 20a in the Hello message and the Flush message.

As an example of an ID for identifying a Hello message and a Flush message, the VRID described in the second embodiment can be used.

By storing, in a Hello message and a Flush message, an ID for identifying a node pair to which the node redundancy protocol is applied, when receiving a Hello message or a Flush message, the master nodes 10 and 10a and the backup nodes 20 and 20a are allowed to determine whether to process the node pair as one of node pairs to which the node redundancy protocol is applied or as Aware nodes.

Since operation of the master nodes 10 and 10a, the backup nodes 20 and 20a and the nodes 50, 60, 90 and 100 is the same as that of the first and second embodiments, no description will be made thereof.

As described above, application of the node redundancy protocol of the present invention enables reliability of a part at which two STP networks are connected with each other to be improved.

### Fifth Embodiment

Next, a network system according to a fifth embodiment of the present invention will be described.

The fifth embodiment will be described with respect to a method for solving a route node failure which requires time for failure recovery by applying the node redundancy protocol of the present invention to a route node of an STP network.

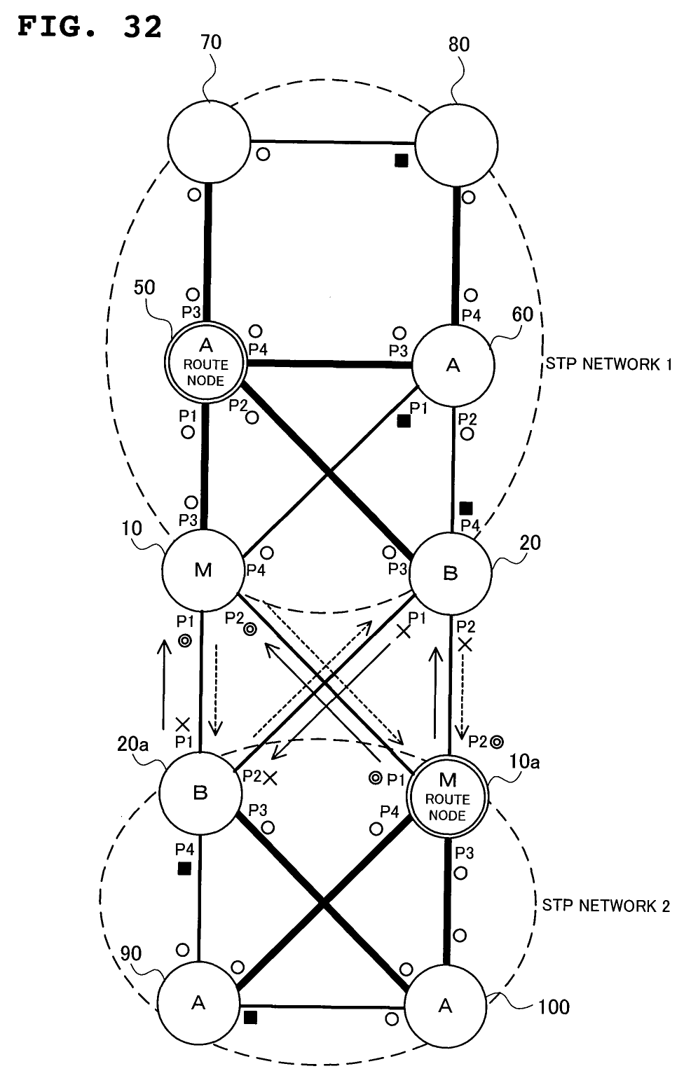

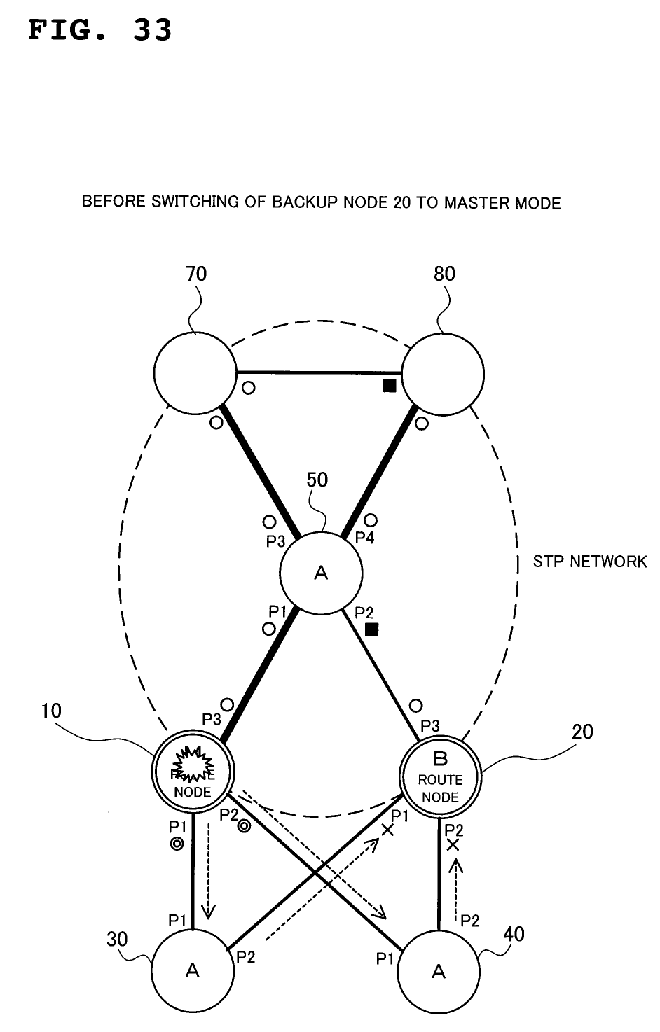

FIG. 33 shows a network system to which the node redundancy protocol is applied in the fifth embodiment.

In FIG. 33, assume that the master node 10 and the backup node 20 form a node pair to which the node redundancy protocol is applied and that in an ordinary state where no failure occurs, the master node 10 is in the master mode and the backup node 20 is in the backup mode.

In addition, the nodes 30, 40 and 50 are Aware nodes of the master node 10 and the backup node 20.

Since operation between the master node 10, the backup node 20 and the nodes 30 and 40 not belonging to the STP network is the same as that of the first embodiment, no description will be made thereof and operation between the master node 10, the backup node 20 and the node 50 in the STP network will be described in the following.

Noting the STP network shown in FIG. 33, the master node 10 and the backup node 20 both operate as a route node of the STP network.

In order to make both nodes of the master node 10 and the backup node 20 function as a route node of the STP network, set as a bridge ID of the STP of the master node 10 and the backup node 20 is a bridge ID having the same value and having priority higher than that of other nodes in the STP network.

In this case, the master node 10 and the backup node 20 transmit a BPDU frame with the same bridge ID stored to the node 50.

When receiving the BPDU frame having the same bridge ID at two ports P1 and P2, if the priority of the bridge ID is the highest in the STP network, the Aware node 50 in the STP network selects a port having received a BPDU frame with a higher priority route path cost as a route port (the state of the port is the forwarding state) and selects a port having received a BPDU frame with a lower priority route path cost as a substitute port (the state of the port is the blocking state).

For terminals under the nodes 50, 70 and 80 in the STP network to be communicable with terminals under the nodes 30 and 40 not belonging to the STP network, it is necessary for the node 50 to select a port to which a node in the master mode is connected as a route port.

Therefore, set a value of a route path cost of the node in the master mode to be smaller than a route path cost of a node in the backup mode.

It is possible, for example, to set the value of a route path cost in the master mode to be ┌0┘ and the value of a route path cost in the backup mode to be 1.

In FIG. 33, the master node 10 in the master mode transmits a BPDU frame with a value of a route path cost set to be ┌0┘ to the node 50, and the backup node 20 in the backup mode transmits a BPDU frame with a value of a route path cost set to be 1 to the node 50.

The node 50 selects the port P1 as a route port and the port 2 as a substitute port, as well as setting a port state of the port P1 to the forwarding state and a port state of the port P2 to the blocking state.

Thus the node redundancy protocol of the present invention can be applied to a route node in the STP network.

In the following, description will be made of a case where when the master node 10 in FIG. 33 goes down to prevent a Hello message from arriving a predetermined number of times, the backup node 20 switches from the backup mode to the master mode.

When the node 50 detects the master node 10 going down (or cut-off of a link between the master node 10 and the node 50) due to link-down of the port P1, the node 50 switches a route port from the port P1 to the port P2 as a substitute port.

In addition, as described in the first embodiment, when the backup node 20 switches from the backup mode to the master mode, the backup node 20 transmits a Flush message through the member ports P1˜P3 of the node redundancy protocol.

The nodes 30, 40 and 50 having received the Flush message rewrites an output port name of an entry whose output port information is the port (P1) having received a Hello message before reception of the Flush message among the entries of the FDB 340 into the port (P2) which has received the Flush message.

In addition, because the backup node 20 switching to the master mode transmits a BPDU frame with a value of a route path cost set to ┌0┘ to the node 50, the node 50 selects the port P2 to which the backup node 20 is directly connected as a route port. Accordingly, even when the master node 10 goes down to switch the backup node 20 to the master mode, the terminals under the nodes 50, 70 and 80 in the STP network are allowed to continue communication with the terminals under the nodes 30 and 40 via the backup node 20.

Furthermore, when the master node 10 recovers from a failure to switch to the master mode and the backup node 20 switches to the backup mode by the procedure described in the first embodiment, the master node 10 in the master mode transmits a BPDU frame whose route path cost value is smaller than that of the backup node 20 in the backup mode to the node 50.

As a result, since the node 50 selects the port P1 to which the master node 10 is directly connected as a route port and the port P2 to which the backup node 20 is directly connected as a substitute port, the terminals under the nodes 50, 70 and 80 in the STP network are allowed to continue communication with the terminals under the nodes 30 and 40 via the master node 10.

As described above, setting a highest priority bridge ID in the STP network to a node to which the node redundancy protocol is applied, and transmitting a BPDU having a route path cost whose priority is higher than that of a node in the backup mode by a node in the master mode enables a route node in the STP network to be made redundant, thereby effectively suppressing occurrence of a failure of a route node which requires time for failure recovery.

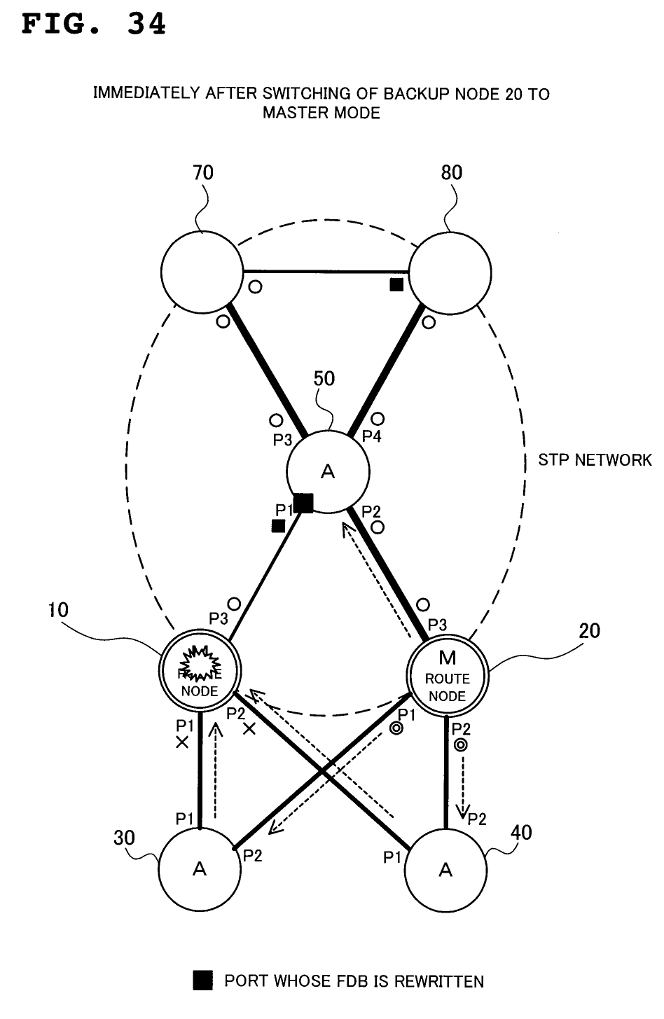

In addition, as shown in the network system in FIG. 35, application of the node redundancy protocol according to the fifth embodiment also to a network system in which the nodes 30 and 40 not belonging to the STP network in FIG. 34 are not connected to the master node 10 and the backup node 20 enables a route node in the STP network to be made redundant.

Operation of the master node 10 and the backup node 20 in FIG. 35 is the same as the above operation of the master node 10 and the backup node 20 in the network system in FIG. 34 except that only the ports P3 and P4 are set as the member ports of the node redundancy protocol.

In addition, operation of the nodes 50 and 60 in FIG. 35 is the same as the operation of the node 50 in the network system in FIG. 34.

Thus, application of the node redundancy protocol of the fifth embodiment to a route node not located at an edge part of the STP network enables the route node to be made redundant.

While the fifth embodiment has been described with respect to a case of making a route node of the STP network be redundant by the master node 10 and the backup node 20, the present invention is applicable also to a case where the network in FIG. 33 is not an ordinary STP network as but a network (STP network) with a plurality of nodes connected which is proposed in Japanese Patent Application No. 2003-041838 (Japanese Patent Laying-Open No. 2004-140777: Literature 1) filed by the present applicant. The network (STP network) recited in Literature 1 is an STP network having a plurality of transfer paths set by a plurality of spanning trees with each edge node as a route node, in which when transferring a frame, frame transfer is executed by using a path set by a spanning tree with an edge node to which a frame transfer destination is connected as a route node.

Here, brief description will be made of the STP network proposed in Japanese Patent Application No. 2003-041838 (Japanese Patent Laying-Open No. 2004-140777: Literature 1).

The network (STP network) recited in Literature 1 will be described in the following with such a network formed by six nodes as shown in FIG. 46 as an example. In this example, all nodes (11˜16) are edge nodes.

FIG. 46 is a block diagram of a spanning tree with the node 11 as a route node. The spanning tree is assumed to be a tree 61. The tree 61 is formed with a priority value of the node 11 set to be a value smaller than that of each node of the node 12˜node 16. Path set by the tree 61 is used for unicast-transmission of a frame from any node of the nodes 12˜16 toward the node 11 and transmission of a broadcast frame from the node 11 to each node of the node 12˜node 16.

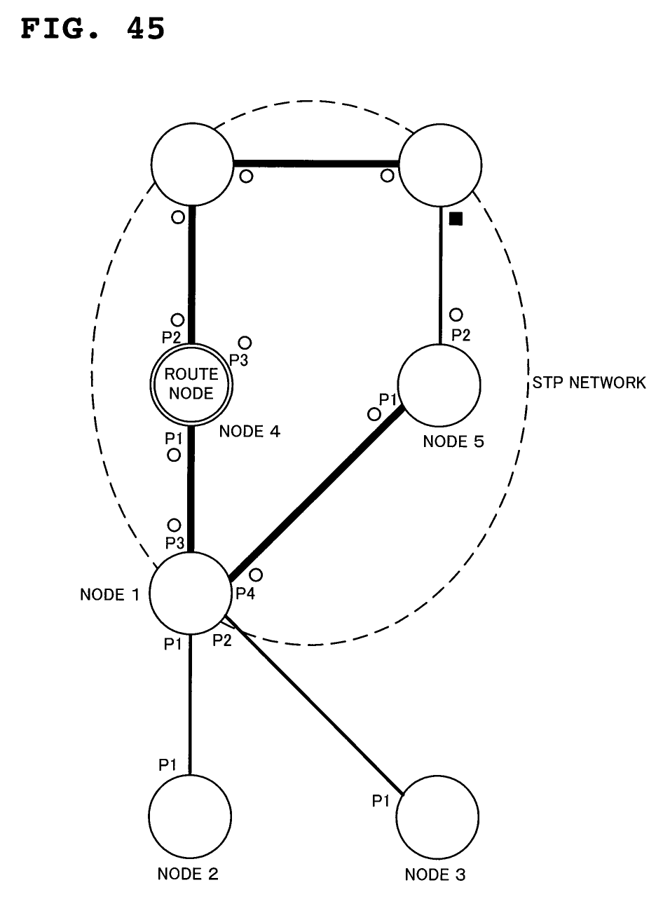

FIG. 47 is a block diagram of a spanning tree with the node 12 as a route node, and the spanning tree is assumed to be a tree 62. The tree 62 is formed with a priority value of the node 12 set to be a value smaller than that of each node of the node 11 and the node 13 P1˜node 16. Path set by the tree 62 is used for unicast-transmission of a frame from any node of the node 11 or the nodes 13˜16 toward the node 12 and transmission of a broadcast frame from the node 12 to each node of the node 11 and the node 13˜the node 16.

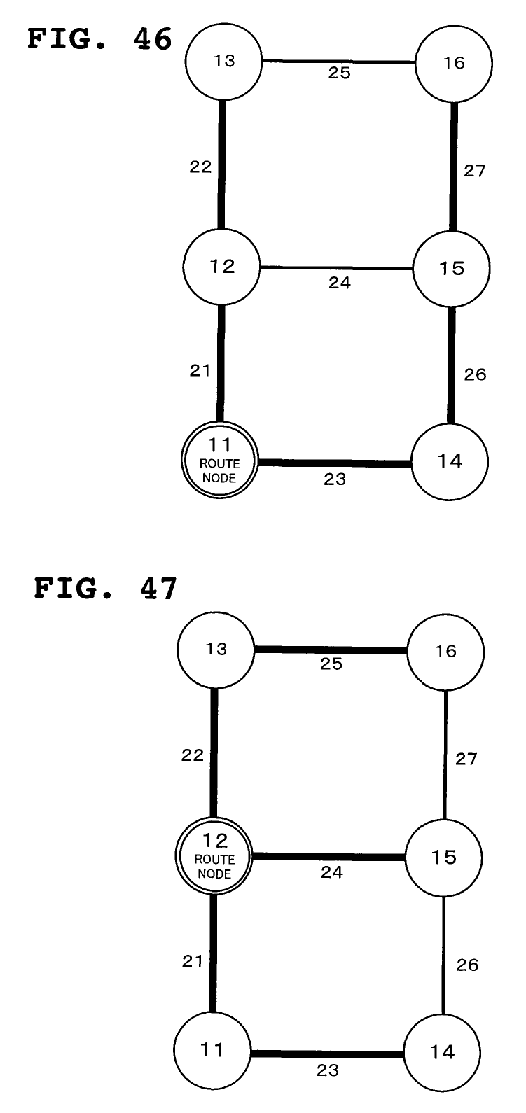

FIG. 48 is a block diagram of a spanning tree with the node 13 as a route node. The spanning tree is assumed to be a tree 63. The tree 63 is formed with a priority value of the node 13 set to be a value smaller than that of each node of the node 11 and the node 12 and the node 14˜the node 16. Path set by the tree 63 is used for unicast-transmission of a frame from any node of the node 11, the node 12 and the node 14˜the node 16 toward the node 13 and transmission of a broadcast frame from the node 13 to each node of the node 11, the node 12 and the node 14˜the node 16.

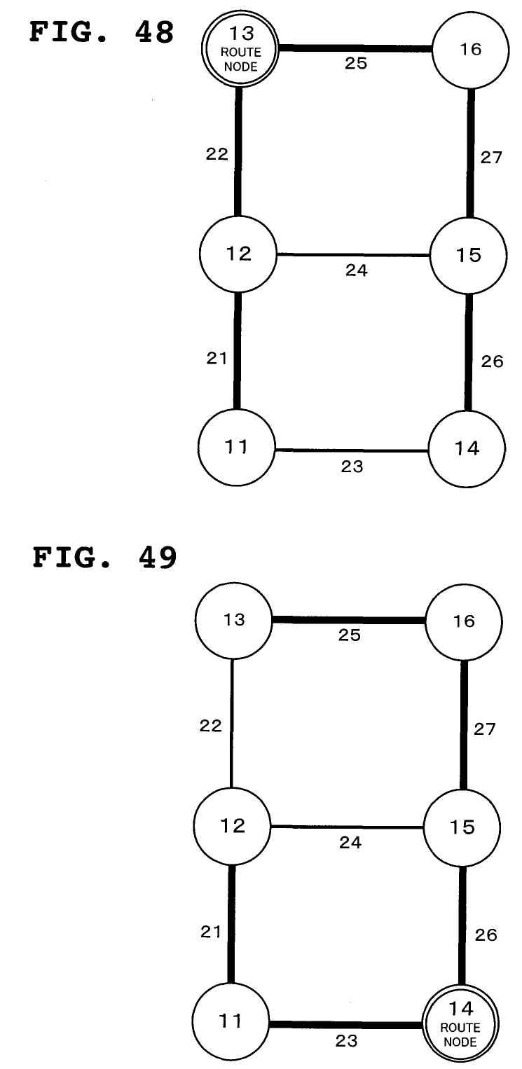

FIG. 49 is a block diagram of a spanning tree with the node 14 as a route node. The spanning tree is assumed to be a tree 64. The tree 64 is formed with a priority value of the node 14 set to be a value smaller than that of each node of the node 11˜the node 13, the node 15 and the node 16. Path set by the tree 64 is used for unicast-transmission of a frame from any node of the node 11˜the node 13, the node 15 and the node 16 toward the node 14 and transmission of a broadcast frame from the node 14 to each node of the node 11˜the node 13, the node 15 and the node 16.

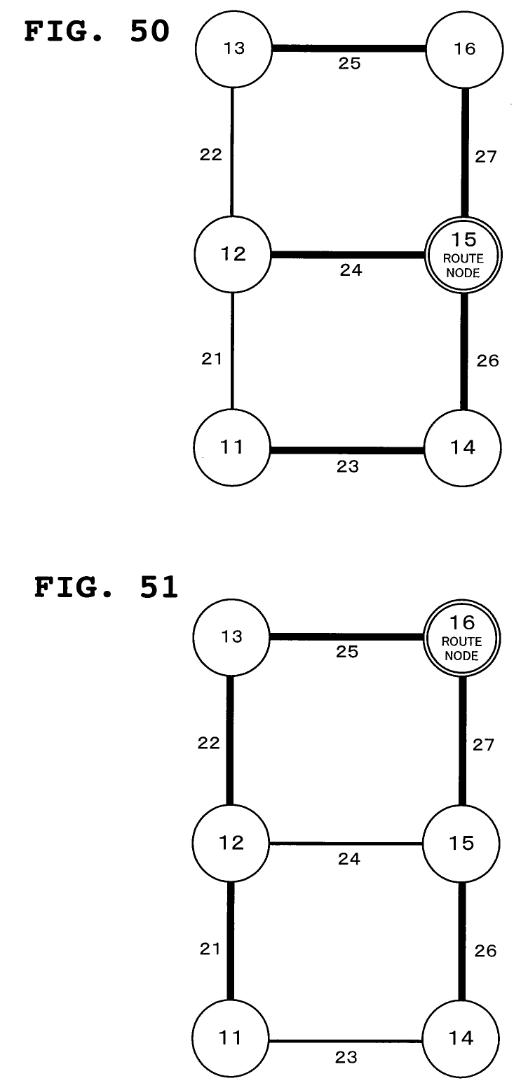

FIG. 50 is a block diagram of a spanning tree with the node 15 as a route node. The spanning tree is assumed to be a tree 65. The tree 65 is formed with a priority value of the node 15 set to be a value smaller than that of each node of the node 11˜the node 14 and the node 16. Path set by the tree 65 is used for unicast-transmission of a frame from any node of the node 11˜the node 14 and the node 16 toward the node 15 and transmission of a broadcast frame from the node 15 to each node of the node 11˜the node 14 and the node 16.

FIG. 51 is a block diagram of a spanning tree with the node 16 as a route node. The spanning tree is assumed to be a tree 66. The tree 66 is formed with a priority value of the node 16 set to be a value smaller than that of each node of the node 11˜the node 15. Path set by the tree 66 is used for unicast-transmission of a frame from any node of the node 11˜the node 15 toward the node 16 and transmission of a broadcast frame from the node 16 to each node of the node 11˜the node 15.

Next, with reference to FIG. 46 to FIG. 51, description will be made of a procedure of transmitting a frame by each node of the node 11˜the node 16 in the figures described above to each node of the node 11˜the node 16 or a terminal under each node. Assume that cost of each link is equal and each tree of the tree 61˜the tree 66 in each figure already has its structure completed to have stable topology.

For unicast-transmitting a frame from each node of the node 12˜node 16 to the node 11 or a terminal under the node, the path set in the tree 61 which is recited in FIG. 46 is used. For transmitting a frame from the node 15 to the node 11, for example, the node 15 transmits a data frame with a tag (e.g. a node ID of the node 11) for identifying the tree 61 attached through an upstream side port in the tree 61 (a route port of the STP in the tree 61). Each node on the path set in the tree 61 identifies a tree for use in transfer of a data frame (the tree 61 in a case where a destination of the data frame is the node 11) by referring to the tag of the data frame and transmits the data frame through the upstream side port in the tree 61. Thus, the data frame is transferred to the node 11 as a route node of the tree 61.

For unicast-transmitting a frame from each node of the node 11 and the node 13˜the node 16 to the node 12 or a terminal under the node, the path set in the tree 62 which is recited in FIG. 47 is used. For transmitting a frame from the node 14 to the node 12, for example, the node 14 transmits a data frame with a tag (e.g. a node ID of the node 12) for identifying the tree 62 attached through an upstream side port in the tree 62 (a route port of the STP in the tree 62). Each node on the path set in the tree 62 identifies a tree for use in transfer of a data frame (the tree 62 in a case where a destination of the data frame is the node 12) by referring to the tag of the data frame and transmits the data frame through the upstream side port in the tree 62. Thus, the data frame is transferred to the node 12 as a route node of the tree 62.

For unicast-transmitting a frame from each node of the node 11, the node 12 and the node 14˜the node 16 to the node 13 or a terminal under the node, the path set in the tree 63 which is recited in FIG. 48 is used. For transmitting a frame from the node 11 to the node 13, for example, the node 11 transmits a data frame with a tag (e.g. a node ID of the node 13) for identifying the tree 63 attached through an upstream side port in the tree 63 (a route port of the STP in the tree 63). Each node on the path set in the tree 63 identifies a tree for use in transfer of a data frame (the tree 63 in a case where a destination of the data frame is the node 13) by referring to the tag of the data frame and transmits the data frame through the upstream side port in the tree 63. Thus, the data frame is transferred to the node 13 as a route node of the tree 63.

For unicast-transmitting a frame from each node of the node 11˜the node 13, the node 15 and the node 16 to the node 14 or a terminal under the node, the path set in the tree 64 which is recited in FIG. 49 is used. For transmitting a frame from the node 12 to the node 14, for example, the node 12 transmits a data frame with a tag (e.g. a node ID of the node 14) for identifying the tree 64 attached through an upstream side port in the tree 64 (a route port of the STP in the tree 64). Each node on the path set in the tree 64 identifies a tree for use in transfer of a data frame (the tree 64 in a case where a destination of the data frame is the node 14) by referring to the tag of the data frame and transmits the data frame through the upstream side port in the tree 64. Thus, the data frame is transferred to the node 14 as a route node of the tree 64.

For unicast-transmitting a frame from each node of the node 11˜the node 14 and the node 16 to the node 15 or a terminal under the node, the path set in the tree 65 which is recited in FIG. 50 is used. For transmitting a frame from the node 16 to the node 15, for example, the node 16 transmits a data frame with a tag (e.g. a node ID of the node 15) for identifying the tree 65 attached through an upstream side port in the tree 65 (a route port of the STP in the tree 61). Each node on the path set in the tree 65 identifies a tree for use in transfer of a data frame (the tree 65 in a case where a destination of the data frame is the node 15) by referring to the tag of the data frame and transmits the data frame through the upstream side port in the tree 65. Thus, the data frame is transferred to the node 15 as a route node of the tree 65.

For unicast-transmitting a frame from each node of the node 11˜the node 15 to the node 16 or a terminal under the node, the path set in the tree 66 which is recited in FIG. 51 is used. For transmitting a frame from the node 14 to the node 16, for example, the node 14 transmits a data frame with a tag (e.g. a node ID of the node 16) for identifying the tree 66 attached through an upstream side port in the tree 66 (a route port of the STP in the tree 66). Each node on the path set in the tree 66 identifies a tree for use in transfer of a data frame (the tree 66 in a case where a destination of the data frame is the node 16) by referring to the tag of the data frame and transmits the data frame through the upstream side port in the tree 66. Thus, the data frame is transferred to the node 16 as a route node of the tree 66.

Application of the node redundancy protocol of the fifth embodiment to an edge node (a route node of a spanning tree) of the STP network recited in Literature 1 which has been described above enables the edge node to be made redundant.

In addition, when applying the node redundancy protocol of the fifth embodiment to a plurality of edge nodes in the STP network recited in Literature 1, as described in the second embodiment, by storing an ID for identifying a node pair to which the node redundancy protocol is applied in a Hello message and a Flush message to prevent erroneous operation of the node redundancy protocol module by a Hello message and a Flush message transmitted by other node pair, a plurality of edge nodes can be made redundant.

By applying the node redundancy protocol of the fifth embodiment to the network (STP network) recited in Literature 1 which has been described above to make an edge node (route node of a spanning tree) of the STP network be redundant, even when a master node of the edge node develops a fault, switching of a backup node to the master mode enables frame transfer to be continued.

When a route node is made redundant by applying the present invention to the STP network recited in Literature 1, it is only necessary to transmit a Flush message only to a port not belonging to member ports of the STP among member ports of the node redundancy protocol.

The reason is that in the STP network based on the data transfer system recited in Literature 1, a node relaying a data frame is not an FDB and a data frame is relayed based on forwarding information (information for identifying a spanning tree used in transferring a data frame) which is stored in a tag of the data frame.

As a result, in the STP network recited in Literature 1 to which the node redundancy protocol of the fifth embodiment is applied, failure recovery can be sped up by a time of rewriting of the FDB by the Aware node 50.

### Sixth Embodiment

Next, a network system according to a sixth embodiment of the present invention will be described.

The sixth embodiment will be described with respect to a case where the node redundancy protocol of the present invention is applied to a part at which STP networks are connected with each other based on the data transfer system proposed in Literature 1 which is shown in the fifth embodiment.

FIG. 36 shows a network system in which the STP network 1 formed of the master node 10, the backup node 20 and the nodes 50, 60 and 70, 80 and the STP network 2 formed of the master node 10a, the backup node 20a and the nodes 90 and 100 are connected with each other by four links which connect the master nodes 10 and 10a and the backup nodes 20 and 20a.

The STP network 1 and the STP network 2 are STP networks based on the data transfer system proposed in Literature 1.

The nodes 50, 60, 70, 80, 90 and 100 are assumed to be nodes adapted to an existing STP which are mounted with the STP module 360 but not the node redundancy protocol module 370.

In the following, description will be made of application of a node redundancy protocol according to the sixth embodiment to the network system shown in FIG. 36.

First, assuming the master node 10 and the backup node 20 of the STP network 1 as a pair of redundant nodes and assuming the nodes 50 and 60 of the STP network 1 and the master node 10a and the backup node 20a of the STP network 2 as Aware nodes of the master node 10 and the backup node 20, apply the node redundancy protocol described in the fifth embodiment.

Next, assuming the master node 10a and the backup node 20a of the STP network 2 as a pair of redundant nodes and assuming the nodes 90 and 100 of the STP network 2 and the master node 10 and the backup node 20 of the STP network 1 as Aware nodes of the master node 11a and the backup node 20a, apply the node redundancy protocol described in the fifth embodiment.

At this time, in the node redundancy protocol according to the sixth embodiment, similarly to the fourth embodiment, the master nodes 10 and 10a and the backup nodes 20 and 20a store an ID for discriminating a Hello message and a Flush message transmitted from the master node 10 and the backup node 20 and a Hello message and a Flush message transmitted from the master node 10a and the backup node 20a in the Hello message and the Flush message.

Since the nodes 50, 60, 70, 80, 90 and 100 are nodes adapted to an existing STP and incapable of recognizing a Hello message, there occurs a problem that a Hello message is broadcast-transferred in the STP network to which each node belongs.

In order to solve the problem, in the node redundancy protocol according to the sixth embodiment, as described in the third embodiment, the master nodes 10 and 11a and the backup nodes 20 and 20a are assumed to refrain from transmitting a Hello message to ports (P3, P4) included in STP member ports among member ports of the node redundancy protocol.

In addition, as described in the fifth embodiment, since in the STP network recited in Literature 1, frame is transferred without referring to an FDB, no transmission of a Flush message is required to the Aware nodes 50, 60, 90 and 100. Accordingly, in the sixth embodiment, the master nodes 10 and 11a and the backup nodes 20 and 20a are assumed to refrain from transmitting a Flush message to the ports (P3, P4) included in the member ports of the STP among member ports of the node redundancy protocol.

When the STP network 1 and the STP network 2 are not the STP network recited in Literature 1 but an STP network in which ordinary frame transfer is executed, it is only necessary to use a BPDU with a Topology Change flag set up as a Flush message at the ports (P3, P4) included in the member ports of the STP among the member ports of the node redundancy protocol as is described in the third embodiment.

Thus the node redundancy protocol can be applied to a part at which STP networks are connected with each other based on the data proposal system proposed in Literature 1.

Such problems as described in the following might however occur.

In the network system shown in FIG. 36, when a link between the master node 10 and the backup node 20aand a link between the backup node 20 and the master node 10a are cut off simultaneously, transmission and reception of a Hello message and a Flush message is disabled between two redundant node pairs (the master node 10 and the backup node 20, and the master node 10a and the backup node 20a), so that a node in the backup mode (the backup nodes 20, 20a) switches to the master mode due a failure of arrival of the Hello message.

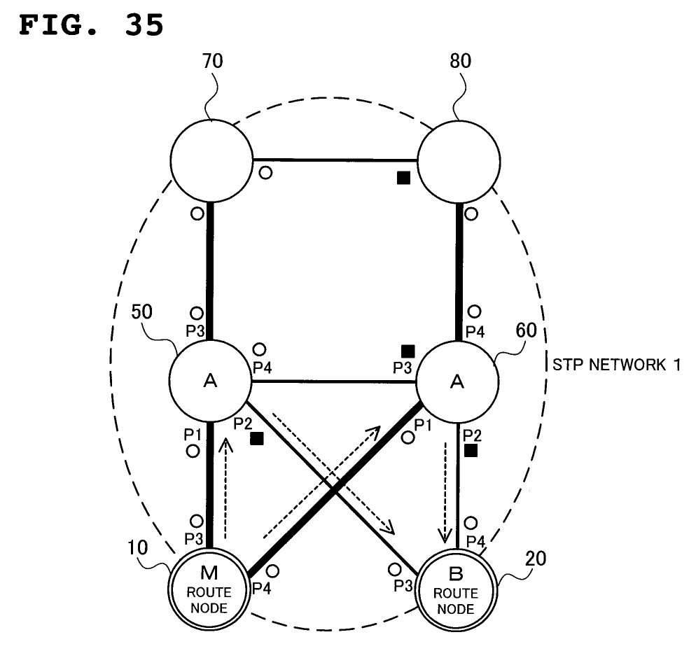

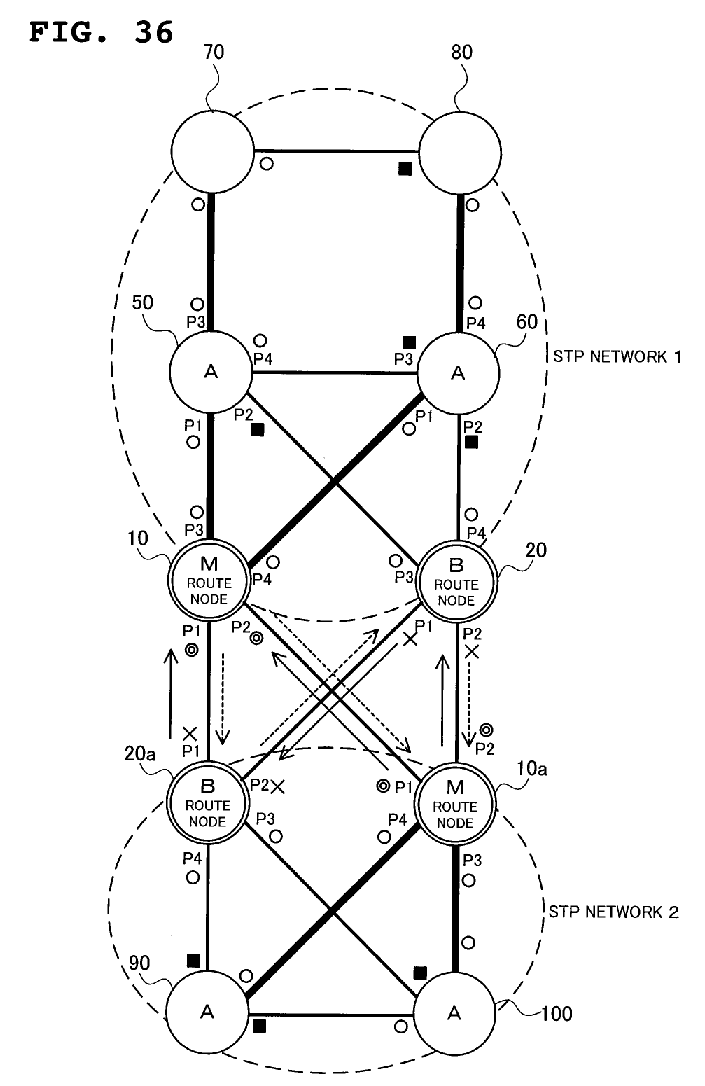

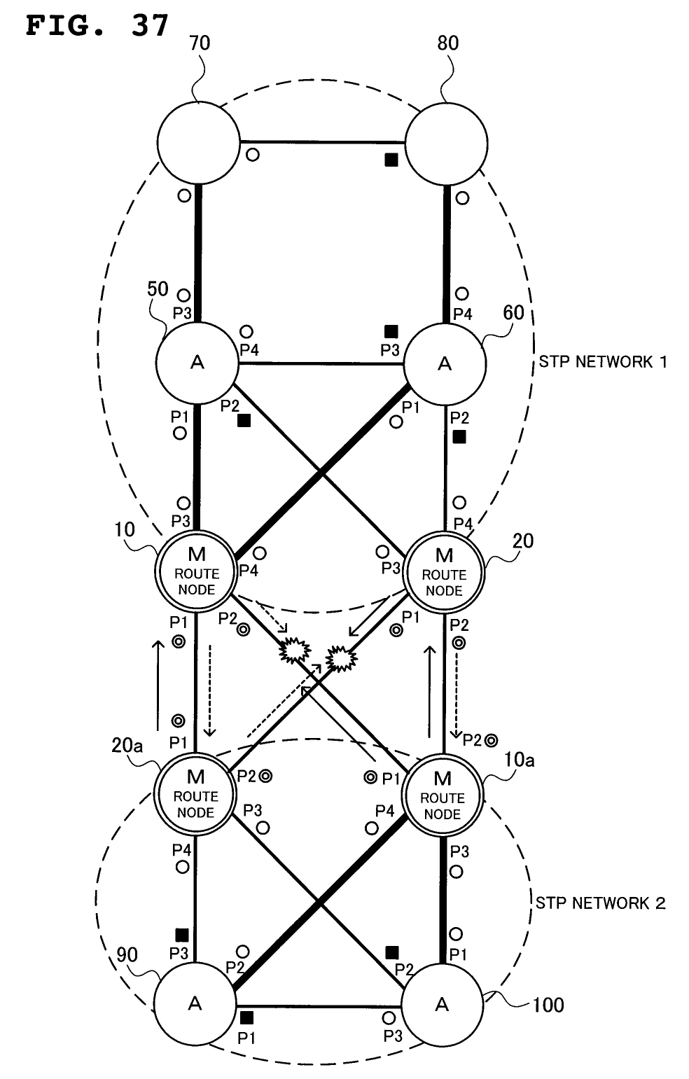

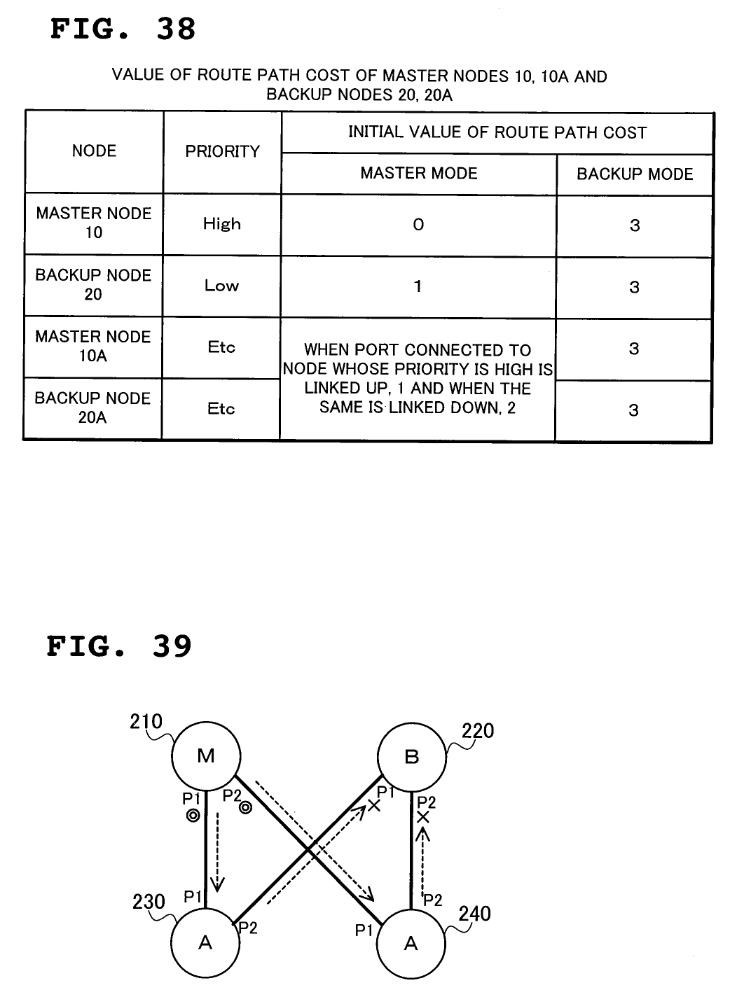

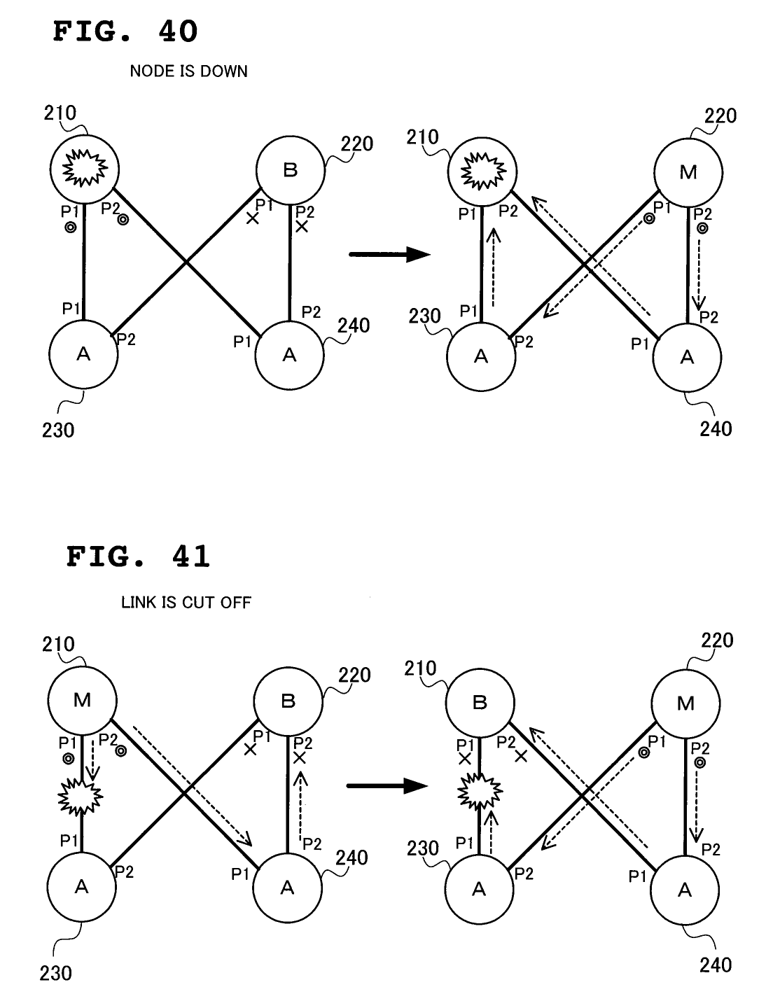

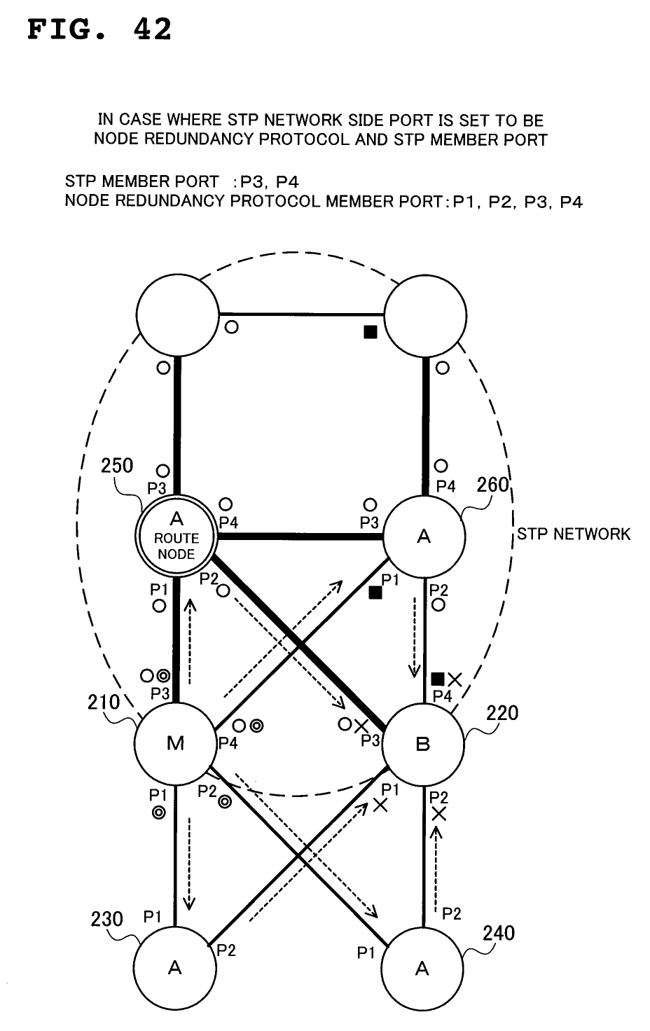

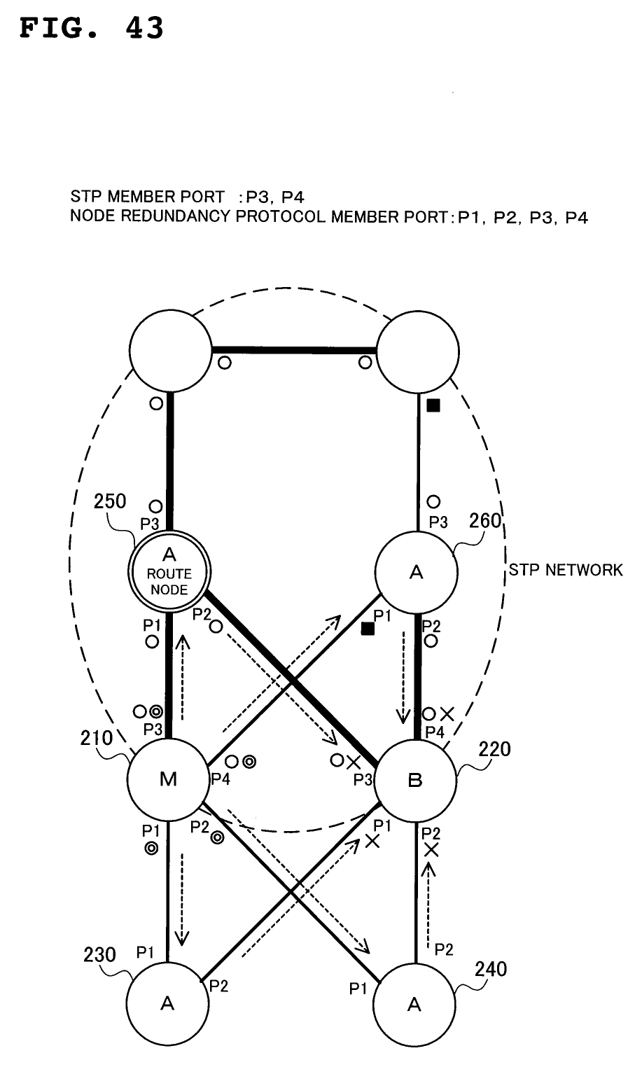

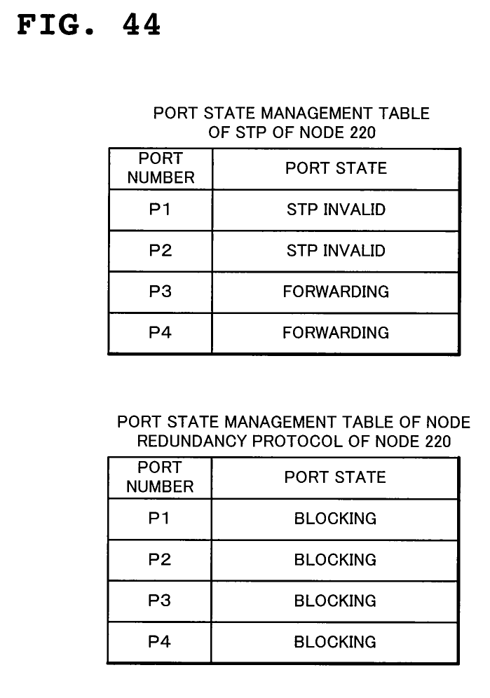

Accordingly, as shown in FIG. 37, there occurs a situation where all the operation states of the master node 10, the master node 10a, the backup node 20 and the backup node 20a enter the master mode.

Also when a link between the master node 10 and the master node 10a and a link between the backup node 20 and the backup node 20a are cut off simultaneously, there occurs a situation where all the operation states of the master node 10, the master node 10a, the backup node 20 and the backup node 20a enter the master mode.

There is a problem that in the above-described state, frame transmission between the STP network 1 and the STP network 2 might be disabled.

In the following, the reason why a frame can not be transmitted between the STP network 1 and the STP network 2 will be described with reference to FIG. 37.

Since both the master node 10 and the backup node 20 are in the master mode, the nodes 50 and 60 receive, at the ports P1 and P2, a BPDU having a bridge ID whose priority is the highest among BPDU received at an STP member port and having the same route path cost.

Similarly, since both the master node 10a and the backup node 20a are in the master mode, the node 90 receives at the ports P1 and P2 and the node 100 receives at the ports P2 and P3, a BPDU having a bridge ID whose priority is the highest among BPDU received at an STP member port and having the same route path cost.

Since when receiving BPDU having the same bridge ID and route path cost at different ports, the nodes 50, 60, 90 and 100 can not determine a route port and a substitute port only by priority of a bridge ID and a route path cost, the nodes determine a route port and a substitute port by using priority of a parameter other than a bridge ID and a route path cost (e.g. a port number of a port through which a BPDU is transmitted or a port number of a port at which a BPDU is received).

Description will be made in the following of a case where among ports at which a BPDU is received, a port whose port number is the smallest is selected as a route port and a port whose port number is the second smallest is selected as a substitute port.

Since the nodes 50 and 60 receive a BPDU having a bridge ID whose priority is the highest and having the same route path cost at the ports P1 and P2, they select the port P1 whose port number is the smallest as a route port and the port P2 as a substitute port.

Similarly, the node 90 selects the port P1 as a route port and the port P2 as a substitute port and the node 100 selects the port P2 as a route port and the port P3 as a substitute port.

As described in the foregoing, when the nodes 30, 40, 50 and 60 select a port to which the master node 10 and the master node 11a are connected as a route port, a link between the master node 10 and the master node 11a is cut off, so that there occurs a problem that frame transmission is disabled between the STP network 1 and the STP network 2.

In the following, description will be made of a method of enabling frame transmission even when operation states of the node redundancy protocol at the master nodes 10 and 10a and the backup nodes 20 and 20a all enter the master mode in FIG. 36.

As shown in FIG. 38, the node redundancy protocol according to the sixth embodiment is designed to set priority to the master nodes 10 and 11a and the backup nodes 20 and 20a and change a route path cost according to an operation state of the node redundancy protocol as shown in FIG. 38.

In the example shown in FIG. 38, the priority of the master node 10 is set to ┌High┘, the priority of the backup node 20 to ┌Low┘ and the priority of the master node 10a and the backup node 20a to ┌Etc┘.

Among priorities of High, Low and Etc, the priority of High is assumed to be the highest, the priority of Low to be the second highest and the priority of Etc to be the lowest.

Furthermore, a value of a route path cost as of when the master node 10 is in the master mode is assumed to be ┌0┘, a value of a route path cost as of when in the backup mode is assumed to be ┌3┘, a value of a route path cost as of when the backup node 20 is in the master mode is assumed to be ┌1┘ and a value of a route path cost as of when in the backup mode is assumed to be ┌3┘.

It is also designed such that a value of a route path cost as of when the master node 10a and the backup node 20a on the STP network 2 side are in the backup mode is assumed to be ┌3┘, and as to a value of a route path cost as of in the master mode, ┌1┘ is set when a port connected to a node whose priority is ┌High┘ links up and ┌2┘ is set when the same links down.

Although the setting contents shown in FIG. 38 is one example and can be freely changed as long as such rules are maintained as priority of one node pair in the STP network is set to ┌High┘ or ┌Low┘, priority of the other node pair in the STP network is set to ┌Etc┘, a value of a route path cost of the node having the priority ┌High┘ is set to be smaller than a value of a route path cost of the node having the priority ┌Low┘, and as to the node with the priority ┌Etc┘, a value of a route path cost of a node whose port connected to the node with the priority ┌High┘ links up is set to be smaller than a value of a route path cost of a node whose port links down.

As described above, when setting the priority and a value of a route path cost based on the setting contents shown in FIG. 38 brings, for example, all the operation states of the master node 10 and the backup node 20 on the STP network 1 side and the master node 10a and the backup node 20a on the STP network 2 side into the master mode, as to the master node 10 and the backup node 20 in the STP network 1, the port P1 whose route path cost value is small and which is connected to the master node 10 is selected as a route port and as to the master node 11a and the backup node 20a in the STP network 2, a value of the route path cost of the master node 10a whose port connected to the master node 10 with the priority ┌High┘ links up becomes smaller than that of the backup node 20a, so that a port connected to the master node 10a (the port P1 in a case of the node 90 and the port P2 in a case of the node 100) will be selected as a route port.

Accordingly, since the nodes 50, 60, 90 and 100 select, among the master nodes 10 and 10a, the backup node 20 and the backup node 20a, a port connected to a node whose link connecting these nodes with each other is active (in the above-described case, the master node 10 and the master node 10a) as a route port, even when all of the master nodes 10, 10a, the backup node 20 and the backup node 20a enter the master mode, data frame transfer is possible.

As described above, according to the sixth embodiment, the problem can be solved that data frame transmission might be disabled in a network system in which STP networks based on the data transfer system proposed by Japanese Patent Application No. 2003-041838 (Japanese Patent Laying-Open No. 2004-140777: Literature 1) are connected with each other even when all the master nodes and the backup nodes at the connection part enter the master mode, so that a network system enabling highly reliable node redundancy can be realized.

In addition, a route node of the STP network can be made redundant to effectively suppress occurrence of a failure of a route node whose failure recovery is time-consuming.

Respective functions of the master node 10, the backup node 20 and the nodes 50, 60, 30 and 40 in the node redundancy network system according to the above-described embodiments can be realized not only as hardware but also by executing a node redundancy control program having the respective functions on a computer processing device forming each node.

The node redundancy control program is stored in such a recording medium as a magnetic disk or a semiconductor memory and loaded from the recording medium into the computer processing device to control operation of the computer processing device, thereby realizing the above-described respective functions.

While the present invention has been described with respect to preferred embodiments in the foregoing, the present invention is not always limited to the above embodiments and can be implemented in various forms within a range of its technical idea.

The node redundancy network system of the present invention attains the excellent effects set forth below.

First, the node redundancy protocol can be applied to a node in a network to which other protocol is applied without contention of port management states.

Secondly, the problem can be solved that when the node redundancy protocol is applied to a node in a network to which other protocol is applied, communication is disabled at the switching between the master mode and the backup mode until an FDB of a node on the side of the network adopting other protocol ages out.

Thirdly, a network system with STP networks connected with each other which enables highly reliable node redundancy can be realized.

Fourthly, a route node of the STP network can be made redundant to effectively suppress occurrence of a failure of a route node whose failure recovery is time-consuming.

1. A network system in which a network adopting a node redundancy protocol and a network adopting other protocol for managing a state of a port coexist,
which is adapted to manage, by said other protocol, a state of a port which belongs to a master node and a backup node forming the network adopting said other protocol and is under the management of said node redundancy protocol and also under the management of said other protocol.

2. The network system according to claim 1, wherein
said master node or backup node transmits a control frame for monitoring a node and a link to all or a part of nodes connected to the port under the management of said node redundancy protocol.

3. The network system according to claim 1 or claim 2, wherein
said master node or backup node transmits a control frame for rewriting a forwarding database to all or a part of nodes connected to the port under the management of said node redundancy protocol at the time of switching to a master mode.

4. The network system according to claim 2 or claim 3, wherein
said master node and said backup node recite, in said control frame, a destination address recognized as unknown at a node connected to said master node and said backup node, and
the node connected to said master node and said backup node broadcasts said control frame.

5. The network system according to any one of claim 2 to claim 4, wherein
in the control frame for monitoring said node and a link and the control frame for rewriting said forwarding data base which are transmitted by said master node or said backup node, identification information for discriminating between said master node and backup node which transmit the control frame and when a plurality of pairs of said master node and backup node exist, for discriminating the pairs of said master node and backup node is stored.

6. The network system according to any one of claim 1 to claim 5, wherein
the network adopting said other protocol is a network adopting VLAN, and
said master node and said backup node manage a state of a port for each VLAN.

7. The network system according to claim 6, wherein
in the control frame for monitoring a node and a link and the control frame for rewriting said forwarding data base which are transmitted by said master node or said backup node in said master mode, identification information for identifying said VLAN is stored.

8. The network system according to claim 3, wherein
said master node and said backup node transmit a BPDU frame with a Topology Change flag based on said STP protocol set up as the control frame for rewriting said forwarding data base to a port belonging to said master node and said backup node and under the management of said node redundancy protocol and also under the management of an STP protocol as said other protocol.

9. The network system according to any one of claim 2 to claim 8, wherein
said master node and said backup node include
a management table which manages a port under the management of said node redundancy protocol, and
a management table which manages a port under the management of said other protocol, wherein
said master node and said backup node transmit said control frame by referring to the management table for managing a port under the management of said node redundancy protocol and the management table for managing a port under the management of said other protocol.

10. The network system according to any one of claim 2 to claim 9, wherein
said master node and said backup node include
a module which controls, when a received frame is a BPDU frame, analysis of said BPDU frame and BPDU frame transmission from a port under the management of said other protocol, and
a module which controls, when said received frame is the control frame for monitoring a node and a link or the control frame for rewriting the forwarding data base, analysis of said control frame and transmission of said control frame from a port under the management of said node redundancy protocol.

11. The network system according to claim 10, wherein
at the time of mode switching of said master node and said backup node, the module which controls transmission of said control frame for rewriting said forwarding data base of said master node or said backup node instructs the module which controls transmission of said BPDU frame to transmit the BPDU frame with the Topology Change flag based on said STP protocol applied to a port under the management of said other protocol.

12. The network system according to claim 11, wherein
said master node and said backup node include a module which applies the Topology Change flag to the BPDU frame transmitted by the module which controls transmission of said BPDU frame.

13. The network system according to claim 12, wherein
at the time of mode switching of said master node and backup node,
the module of said master node or said backup node which controls transmission of said control frame for rewriting said forwarding data base instructs the module which applies the Topology Change flag to said BPDU frame to apply the Topology Change flag based on said STP protocol to the BPDU frame transmitted from a port which is a port belonging to said master node and said backup node and under the management of said node redundancy protocol and which is a port under the management of said STP protocol in the module which controls transmission of said BPDU frame.

14. The network system according to any one of claim 2 to claim 10, wherein
a node connected to said master node and said backup node includes
a module which transmits said control frame received to said master node or said backup node, and
a module which rewrites said forwarding data base upon reception of the control frame for rewriting said forwarding data base.

15. The network system according to any one of claim 1 to claim 14, wherein
said master node and said backup node are formed to have a network structure in which the nodes are route nodes of the network adopting the STP protocol as said other protocol, and
among said master node and said backup node, a value of a route path cost of a node in the master mode is set to be smaller than a value of a node in a backup mode.

16. The network system according to any one of claim 1 to claim 14, wherein
the networks adopting the STP protocol as said other protocol are connected with each other at a part where said master node and said backup node forming said network are duplicated,
priority is set to said master node and said backup node belonging to one said network,
among said master node and said backup node, a value of a route path cost of a node with high priority set is set to be smaller in the master mode than a value of a node with low priority set, and
when a port connected to said node with high priority set is active, values of route path cost of said master node and said backup node belonging to other said network are set to be smaller in the master mode than values obtained when the port fails to be active.

17. The network system according to claim 15 or claim 16, wherein
the network adopting said other protocol is a network in which a plurality of transfer paths are set by a plurality of spanning trees with each edge node of said network as a route node, and
frame transfer is executed by using a path set by a spanning tree with an edge node to which a frame transfer destination is connected as a route node.

18. A node of a network system with a network adopting a node redundancy protocol and a network adopting other protocol for managing a state of a port coexisting,
which is adapted to manage, by said other protocol, a state of a port belonging to a node having a master mode and a backup mode which forms the network adopting said other protocol and is under the management of said node redundancy protocol and also under the management of said other protocol.

19. The node according to claim 18, which node in said master mode or backup mode transmits a control frame for monitoring a node and a link to all or a part of nodes connected to the port under the management of said node redundancy protocol.

20. The node according to claim 18 or claim 19, wherein, at the time of switching to the master mode, transmits a control frame for rewriting a forwarding database to all or a part of nodes connected to the port under the management of said node redundancy protocol.

21. The node according to claim 19 or claim 20, which node in said master mode and node in said backup mode recite, in said control frame, a destination address recognized as unknown at a node connected to the node in said master mode and the node in said backup mode, and
the node connected to the node in said master mode and the node in said backup mode broadcasts said control frame.

22. The node according to any one of claim 19 to claim 21, wherein
in the control frame for monitoring said node and a link and the control frame for rewriting said forwarding data base which are transmitted by the node in said master mode or the node in said backup mode, identification information for discriminating between said master node and backup node which transmit the control frame and when a plurality of pairs of said master node and backup node exist, for discriminating the pairs of said master node and backup node is stored.

23. The node according to any one of claim 18 to claim 22, wherein
the network adopting said other protocol is a network adopting VLAN, and
the node in said master mode and the node in said backup mode manage a state of a port for each VLAN.

24. The node according to claim 23, wherein
in the control frame for monitoring a node and a link and the control frame for rewriting said forwarding data base which are transmitted by the node in said master mode, identification information for identifying said VLAN is stored.

25. The node according to claim 20, which node in said master mode and node in said backup mode transmit a BPDU frame with a Topology Change flag based on said STP protocol set up as the control frame for rewriting said forwarding data base to a port belonging to the node in said master mode and the node in said backup mode and under the management of said node redundancy protocol and under the management of an STP protocol as said other protocol.

26. The node according to any one of claim 19 to claim 25, which node in said master mode and node in said backup mode include a management table which manages a port under the management of said node redundancy protocol, and a management table for managing a port under the management of said other protocol, wherein
transmit said control frame by referring to the management table for managing a port under the management of said node redundancy protocol and the management table for managing a port under the management of said other protocol.

27. The node according to any one of claim 19 to claim 26, which node in said master mode and node in said backup mode include
a module which controls, when a received frame is a BPDU frame, analysis of said BPDU frame and BPDU frame transmission from a port under the management of said other protocol, and
a module which controls, when said received frame is the control frame for monitoring a node and a link or the control frame for rewriting the forwarding data base, analysis of said control frame and control frame transmission from a port under the management of said node redundancy protocol.

28. The node according to claim 27, wherein
at the time of mode switching between said master mode and said backup mode, the module of the node in said master mode or the node in said backup mode which 5 controls transmission of said control frame for rewriting said forwarding data base instructs the module which controls transmission of said BPDU frame to transmit the BPDU frame with the Topology Change flag based on said STP protocol applied to a port under the management of said other protocol.

29. The node according to claim 28, which the node in said master mode and node in said backup mode include a module which applies the Topology Change flag to the BPDU frame transmitted by the module which controls transmission of said BPDU frame.

30. The node according to claim 29, wherein
at the time of mode switching between said master mode and backup mode, the module of the node in said master mode or the node in said backup mode which controls transmission of said control frame for rewriting said forwarding data base instructs the module which applies the Topology Change flag to said BPDU frame to apply the Topology Change flag based on said STP protocol to the BPDU frame transmitted from a port which is a port belonging to the node in said master mode and the node in said backup mode and under the management of said node redundancy protocol and which is a port under the management of said STP protocol in the module which controls transmission of said BPDU frame.

31. The node according to any one of claim 19 to claim 27, which node connected to the node in said master mode or the node in said backup mode includes
a module which transmits said control frame received to the node in said master mode or the node in said backup mode, and
a module which rewrites the forwarding data base upon reception of the control frame for rewriting the forwarding data base.

32. A node control program for controlling node redundancy which is executed on a master node and a backup node in a node redundancy network system in which a network adopting a node redundancy protocol and a network adopting other protocol for managing a state of a port coexist, comprising the function of
managing, by said other protocol, a state of a port which belongs to the master node and the backup node forming the network adopting said other protocol and is under the management of said node redundancy protocol and also under the management of said other protocol.

33. The node control program according to claim 32, wherein
said master node or backup node has the function of transmitting a control frame for monitoring a node and a link to all or a part of nodes connected to the port under the management of said node redundancy protocol.

34. The node control program according to claim 32 or claim 33, further including the function of transmitting a control frame for rewriting a forwarding database to all or a part of nodes connected to the port under the management of said node redundancy protocol at the time of switching to a master mode.

35. The node control program according to claim 33 or claim 34, wherein
said master node and said backup node have the function of reciting, in said control frame, a destination address recognized as unknown at a node connected to said master node and said backup node, and
the node connected to the node in said master mode and the node in said backup mode has the function of broadcasting said control frame.

36. The node control program according to any one of claim 33 to claim 35, further including the function of storing, in the control frame for monitoring said node and a link and the control frame for rewriting said forwarding data base which are transmitted by said master node or said backup node, identification information for discriminating between said master node and backup node which transmit the control frame and when a plurality of pairs of said master node and backup node exist, for discriminating the pairs of said master node and backup node.

37. The node control program according to any one of claim 32 to claim 36, wherein
the network adopting said other protocol is a network adopting VLAN, and
said master node and said backup node have the function of managing a state of a port for each VLAN.

38. The node control program according to claim 37, further including the function of storing, in the control frame for monitoring a node and a link and the control frame for rewriting said forwarding data base which are transmitted by said master node, identification information for identifying said VLAN.

39. The node control program according to claim 34, wherein
said master node and said backup node have the function of transmitting a BPDU frame with a Topology Change flag based on said STP protocol applied as the control frame for rewriting said forwarding data base to a port belonging to said master node and said backup node and under the management of said node redundancy protocol and also under the management of an STP protocol as said other protocol.

40. The node control program according to any one of claim 33 to claim 39, wherein said master node and said backup node comprise a management table which manages a port under the management of said node redundancy protocol, and a management table which manages a port under the management of said other protocol, and
include the function of transmitting said control frame by referring to the management table for managing a port under the management of said node redundancy protocol and the management table for managing a port under the management of said other protocol.

41. The node control program according to any one of claim 33 to claim 40, wherein said master node and said backup node include
the function of controlling, when a received frame is a BPDU frame, analysis of said BPDU frame and BPDU frame transmission from a port under the management of said other protocol, and
the function of controlling, when said received frame is the control frame for monitoring a node and a link or the control frame for rewriting the forwarding data base, analysis of said control frame and control frame transmission from a port under the management of said node redundancy protocol.

42. The node control program according to claim 41, wherein
at the time of mode switching of said master node and said backup node, the function of the node in said master mode or the node in said backup mode of controlling transmission of said control frame for rewriting said forwarding data base instructs the function of controlling transmission of said BPDU frame to transmit the BPDU frame with the Topology Change flag based on said STP protocol applied to a port under the management of said other protocol.

43. The node control program according to claim 42, wherein
said master node and said backup node include the function of applying the Topology Change flag to the BPDU frame transmitted by the module which controls transmission of said BPDU frame.

44. The node control program according to claim 43, wherein
at the time of mode switching of said master node and backup node, the function of said master node or said backup node of controlling transmission of said control frame for rewriting said forwarding data base instructs the function of applying the Topology Change flag to said BPDU frame to apply the Topology Change flag based on said STP protocol to the BPDU frame transmitted from a port which is a port belonging to said master node and said backup node and under the management of said node redundancy protocol and which is a port under the management of said STP protocol in the function of controlling transmission of said BPDU frame.

45. The node control program according to any one of claim 33 to claim 41, wherein a node connected to said master node or said backup node includes
the function of transmitting said control frame received to said master node or said backup node, and
the function of rewriting the forwarding data base upon reception of the control frame for rewriting the forwarding data base.

46. A network control method of controlling node redundancy in a node redundancy network system in which a network adopting a node redundancy protocol and a network adopting other protocol for managing a state of a port coexist, the method including the step of:
a step of managing, by said other protocol, a state of a port which belongs to a master node and a backup node forming the network adopting said other protocol and is under the management of said node redundancy protocol and also under the management of said other protocol.

47. The network control method according to claim 46, further including the step of transmitting, at said master node or backup node, a control frame for monitoring a node and a link to all or a part of nodes connected to the port under the management of said node redundancy protocol.

48. The network control method according to claim 46 or claim 47, further including the step of transmitting a control frame for rewriting a forwarding database to all or a part of nodes connected to the port under the management of said node redundancy protocol at the time of switching to a master mode.

49. The network control method according to claim 47 or claim 48, further including:
the step of reciting, at said master node and said backup node, in said control frame, a destination address recognized as unknown at a node connected to said master node and said backup node, and
the step of broadcasting said control frame in the node connected to the node in said master mode and the node in said backup mode.

50. The network control method according to any one of claim 47 to claim 49, further including the step of storing, in the control frame for monitoring said node and a link and the control frame for rewriting said forwarding data base which are transmitted by said master node or said backup node, identification information for discriminating between said master node and backup node which transmit the control frame and when a plurality of pairs of said master node and backup node exist, for discriminating the pairs of said master node and backup node.

51. The network control method according to any one of claim 46 to claim 50, wherein
the network adopting said other protocol is a network adopting VLAN, and which includes
the step of managing a state of a port for each VLAN at said master node and said backup node.

52. The network control method according to claim 51, further including the step of storing, in the control frame for monitoring a node and a link and the control frame for rewriting said forwarding data base which are transmitted by said master node, identification information for identifying said VLAN.

53. The network control method according to claim 48, further including the step of transmitting, at said master node and said backup node, a BPDU frame with a Topology Change flag based on said STP protocol applied as the control frame for rewriting said forwarding data base to a port belonging to said master node and said backup node and under the management of said node redundancy protocol and also under the management of an STP protocol as said other protocol.

54. The network control method according to any one of claim 47 to claim 53, wherein said master node and said backup node comprise a management table which manages a port under the management of said node redundancy protocol, and a management table which manages a port under the management of said other protocol, and
including the step of transmitting said control frame by referring to the management table for managing a port under the management of said node redundancy protocol and the management table for managing a port under the management of said other protocol.

55. The network control method according to any one of claim 47 to claim 54, further including:
the step of controlling, when at said master node and said backup node, a received frame is a BPDU frame, analysis of said BPDU frame and BPDU frame transmission from a port under the management of said other protocol, and
the step of controlling, when said received frame is the control frame for monitoring a node and a link or the control frame for rewriting the forwarding data base, analysis of said control frame and control frame transmission from a port under the management of said node redundancy protocol.

56. The network control method according to claim 55, wherein
at the time of mode switching of said master node and said backup node, the step of the node in said master mode or the node in said backup mode of controlling transmission of said control frame for rewriting said forwarding data base instructs the step of controlling transmission of said BPDU frame to transmit the BPDU frame with the Topology Change flag based on said STP protocol applied to a port under the management of said other protocol.

57. The network control method according to claim 56, further including the step of applying, at said master node and said backup node, the Topology Change flag to the BPDU frame transmitted by a module which controls transmission of said BPDU frame.

58. The network control method according to claim 57, wherein
at the time of mode switching of said master node and backup node, the step of said master node or said backup node of controlling transmission of said control frame for rewriting said forwarding data base instructs the step of applying the Topology Change flag to said BPDU frame to apply the Topology Change flag based on said STP protocol to the BPDU frame transmitted from a port which is a port belonging to said master node and said backup node and under the management of said node redundancy protocol and which is a port under the management of said STP protocol at the step of controlling transmission of said BPDU frame.

59. The network control method according to any one of claim 47 to claim 55, further including the steps of, at a node connected to said master node and said backup node:
transmitting said control frame received to said master node or said backup node, and
rewriting the forwarding data base upon reception of the control frame for rewriting the forwarding data base.

60. The network control method according to any one of claim 46 to claim 59, wherein
said master node and said backup node are formed to have a network structure in which the nodes are route nodes of the network adopting the STP protocol as said other protocol, and
among said master node and said backup node, a value of a route path cost of a node in the master mode is set to be smaller than a value of a node in the backup mode.

61. The network control method according to any one of claim 46 to claim 59, wherein
the networks adopting the STP protocol as said other protocol are connected with each other at a part where said master node and said backup node forming said network are duplicated,
priority is set to said master node and said backup node belonging to one said network,
among said master node and said backup node, a value of a route path cost of a node with high priority set is set to be smaller in the master mode than a value of a node with low priority set, and
when a port connected to said node with high priority set is active, values of route path cost of said master node and said backup node belonging to other said network are set to be smaller in the master mode than values obtained when the port fails to be active.

62. The network control method according to claim 60 or claim 61, wherein the network adopting said other protocol is a network in which a plurality of transfer paths are set by a plurality of spanning trees with each edge node of said network as a route node, and
frame transfer is executed by using a path set by a spanning tree with an edge node to which a frame transfer destination is connected as a route node.
